(19) United States
(12) Patent Application Publication
(10) Pub. No.: US 2017/0039525 A1
(43) Pub. Date: Feb. 9, 2017

(54) SYSTEMS AND METHODS FOR MANAGING, TRACKING, AND OFFERING EMPLOYMENT

(71) Applicants: Mike Seidle, Indianapolis, IN (US); Richard Wehrle, Zionsville, IN (US); Howard Bates, Carmel, IN (US)

(72) Inventors: Mike Seidle, Indianapolis, IN (US); Richard Wehrle, Zionsville, IN (US); Howard Bates, Carmel, IN (US)

(21) Appl. No.: 15/227,562

(22) Filed: Aug. 3, 2016

Related U.S. Application Data
(60) Provisional application No. 62/200,306, filed on Aug. 3, 2015.

(51) Int. Cl. G06Q 10/10

(52) U.S. Cl. CPC G06Q 10/1053; G06Q 50/01

(57) ABSTRACT

Methods and systems for establishing an employment tracking social platform over a computer network. In one aspect, a method includes receiving and storing user login information; receiving and storing employment information, where the employment information includes one or more employment places and one or more employment positions, and where the one or more employment place and the one or more employment position have corresponding geographic coordinates; receiving and storing user geographic location information from the one or more users; matching the stored user geographic location information with the corresponding geographic coordinates of the one or more employment places and the one or more employment positions; and returning employment information within one or more user-defined thresholds to the one or more users for display.

### CROSS-REFERENCE TO RELATED APPLICATIONS

This application claims the benefit under 35 U.S.C. §119(e) of U.S. Patent Application No. 62/200,306, entitled “SYSTEMS AND METHODS FOR MANAGING, TRACKING, AND OFFERING EMPLOYMENT,” filed Aug. 3, 2015, which is incorporated herein by reference in its entirety.

### BACKGROUND

This specification relates to the field of software. More specifically, the present technology is in the technical field of software-based employment tracking enabling a crowdsourced and/or machine learning driven employment social network system.

Every year, vast numbers of unskilled employment opportunities go unfilled by unemployed individuals, despite an ever-present demand. This is oftentimes due to lack of knowledge of the positions, the lack of ability to track openings, and the reputation of these unskilled labor positions. Many of these positions also have a high-turnover rate, leading to frequent but repeated openings, little notice to potential job seekers, and strain on the business to fill positions efficiently. Overall, the volatile environment leads to difficulties in discovering and securing reliable placements by both employers and employees. Furthermore, no reasonable methods are available to actively rate and compare different franchises, employers, positions, and/or the like except sporadic and highly biased word of mouth, information which is highly desirable and useful to those offering and/or applying for employment.

The present novel technology addresses these needs.

### SUMMARY

This specification relates to the field of software. More specifically, the present technology is in the technical field of software-based employment tracking enabling a crowdsourced and/or machine learning driven employment social network system.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 depicts an example environment in which the employment tracking system may exist.

FIG. 2 depicts an example hardware environment that may implement the employment tracking system of FIG. 1.

FIG. 3 depicts a screenshot of the system's places tab.

FIG. 4 depicts a screenshot of the system's places tab sorted by distance.

FIG. 5 depicts a screenshot of the system's places tab sorted by positions.

FIG. 6 depicts a screenshot of the system's places tab sorted by followers.

FIG. 7 depicts a screenshot of the system's place details tab's rating subtab.

FIG. 8 depicts a screenshot of the system's place details tab's people subtab.

FIG. 9 depicts a screenshot of the system's place details tab's positions subtab.

FIG. 10 depicts a screenshot of the system's places tab with map view.

FIG. 11 depicts a screenshot of the system's places tab with location popup.

FIG. 12 depicts a screenshot of the system's positions tab.

FIG. 13 depicts a screenshot of the system's people tab and following subtab.

FIG. 14 depicts a screenshot of the system's people tab and followers subtab.

FIG. 15 depicts a screenshot of the system's people sorted by followers.

FIG. 16 depicts a screenshot of the system's people sorted by following.

FIG. 17 depicts a screenshot of the system's people sorted by distance.

FIG. 18 depicts a screenshot of the system's user profile tab with editing and places subtab.

FIG. 19 depicts a screenshot of the user profile tab with editing and positions subtab.

FIG. 20 depicts a screenshot of the system's user profile tab with editing and following subtab.

FIG. 21 depicts a screenshot of the system's chat view associated with the present novel technology.

FIG. 22 depicts a screenshot of the system's position detail view associated with the present novel technology.

FIG. 23 depicts a screenshot of the system's employer dashboard view associated with the present novel technology.

FIG. 24 depicts a screenshot of the system's employer net promoter score (eNPS) view associated with the present novel technology.

FIG. 25 depicts a screenshot of the system's events view associated with the present novel technology.

FIG. 26 depicts a screenshot of the system's event detail view associated with the present novel technology.

FIG. 27 depicts a screenshot of the system's messages view associated with the present novel technology.

FIGS. 28A-28B depict a high-level process flow associated with the present novel technology.

FIG. 29 depicts a screenshot of another implementation of the system's map view associated with the present novel technology.

FIG. 30 depicts a screenshot of another implementation of the system's people view associated with the present novel technology.

FIG. 31 depicts a screenshot of another implementation of the system's places view associated with the present novel technology.

FIG. 32 depicts a screenshot of another implementation of the system's positions view associated with the present novel technology.

FIG. 33 depicts a screenshot of another implementation of the system's profile places detail view associated with the present novel technology.

FIG. 34 depicts a screenshot of another implementation of the system's user profile view associated with the present novel technology.

Like reference numbers and designations in the various drawings indicate like elements.

### DETAILED DESCRIPTION

Before the present methods, implementations, and systems are disclosed and described, it is to be understood that this invention is not limited to specific synthetic methods, specific components, implementation, or to particular compositions, and as such may, of course, vary. It is also to be understood that the terminology used herein is for the purpose of describing particular implementations only and is not intended to be limiting.

As used in the specification and the claims, the singular forms “a,” an and the include plural referents unless the context clearly dictates otherwise. Ranges may be expressed in ways including from “about” one particular value, and/or to “about” another particular value. When such a range is expressed, another implementation may include from the one particular value and/or to the other particular value. Similarly, when values are expressed as approximations, for example by use of the antecedent “about,” it will be understood that the particular value forms another implementation. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not. Similarly, “typical” or “typically” means that the subsequently described event or circumstance often though may not occur, and that the description includes instances where said event or circumstance occurs and instances where it does not. Additionally, “generates,” “populates,” “generating,” and “populating” mean that employment tracking system 105, client, end user (user, system user), and/or module may produce some event or cause some event element to be produced. For example, a webpage may receive data to display in whole or in part to display a valuation estimate to an end user device, the webpage may pull such data from a source other than system 105 (e.g., other servers, intermediaries, etc.), or system 105 may entirely provide the valuation estimate to be produced on the webpage.

“Click,” “touch,” and “tap” are terms that typically may be used interchangeably. For example, on a mobile device, users typically touch or tap the screen to select items or press buttons. On a laptop, smartphone, and/or desktop users typically click with a mouse, but may in some implementations use a touchscreen or the like interface.

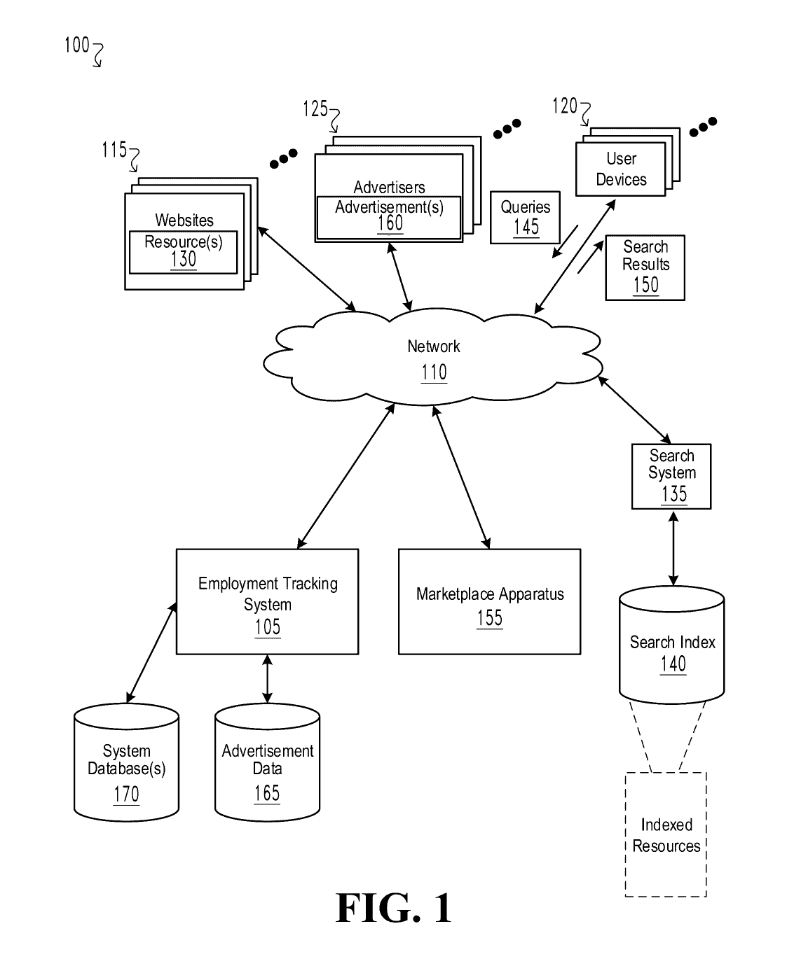

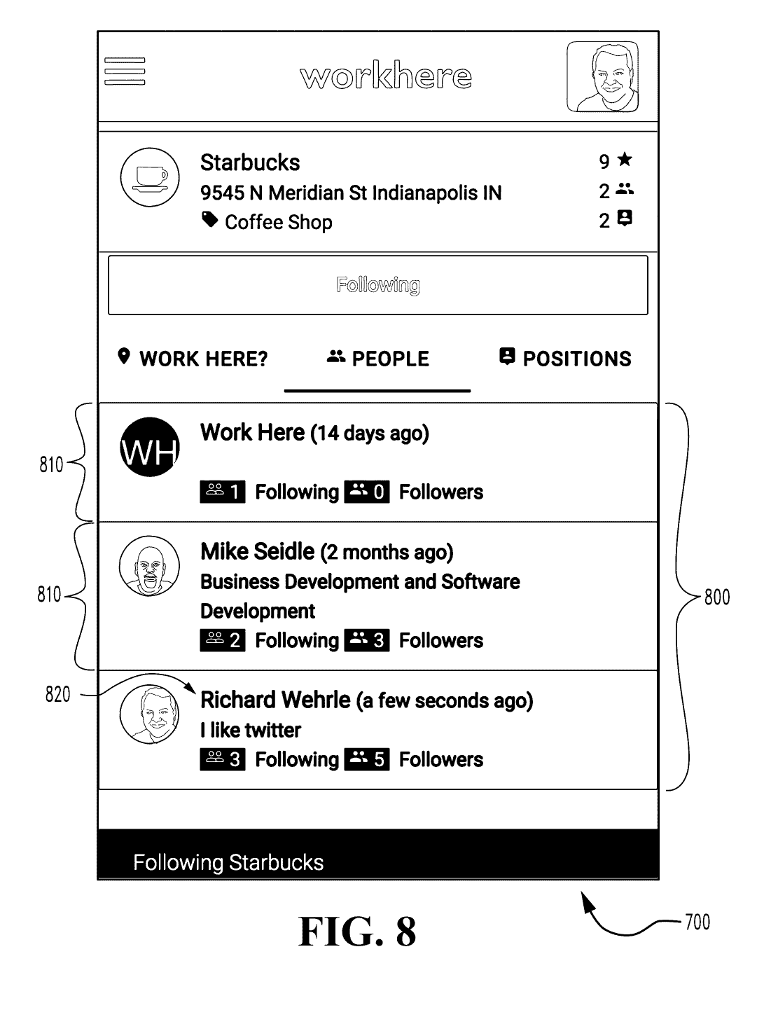

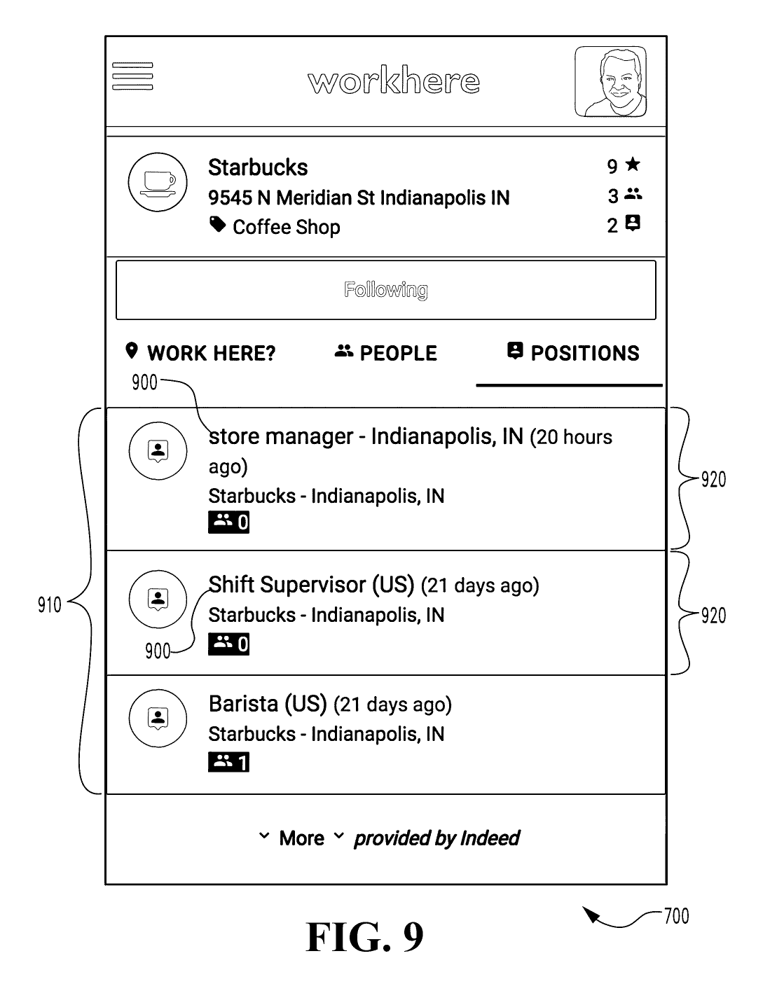

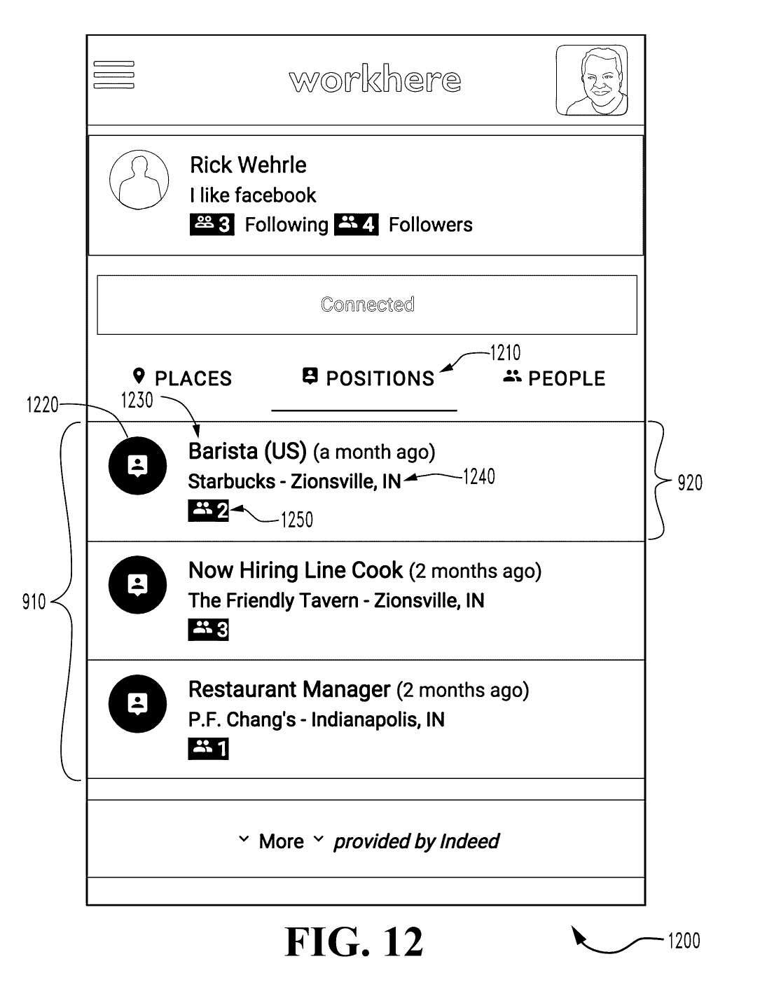

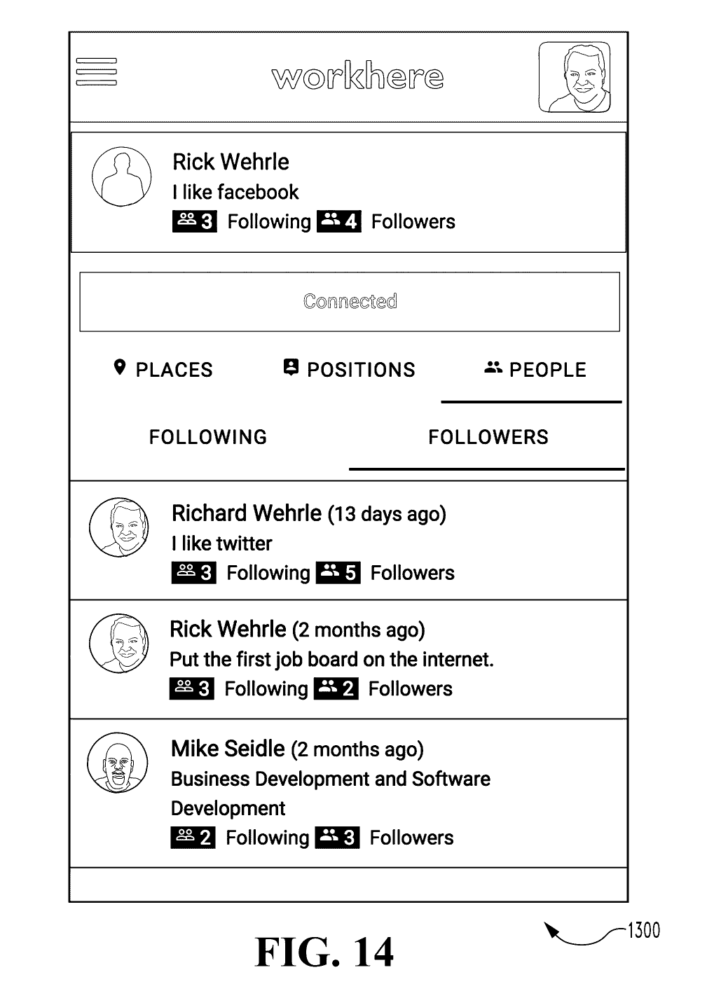

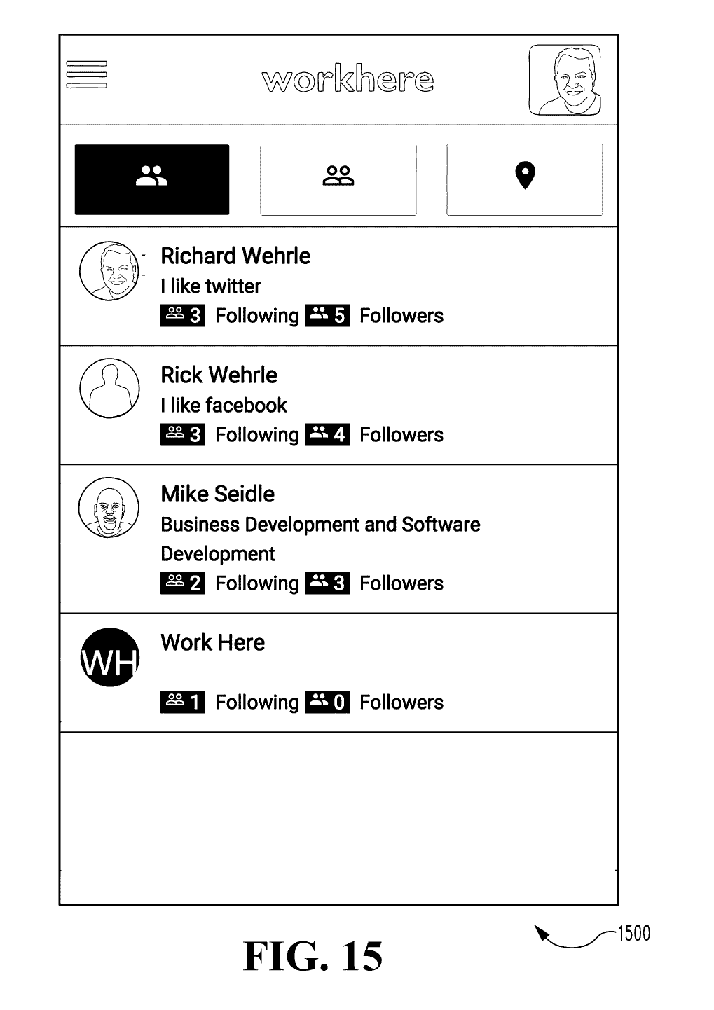

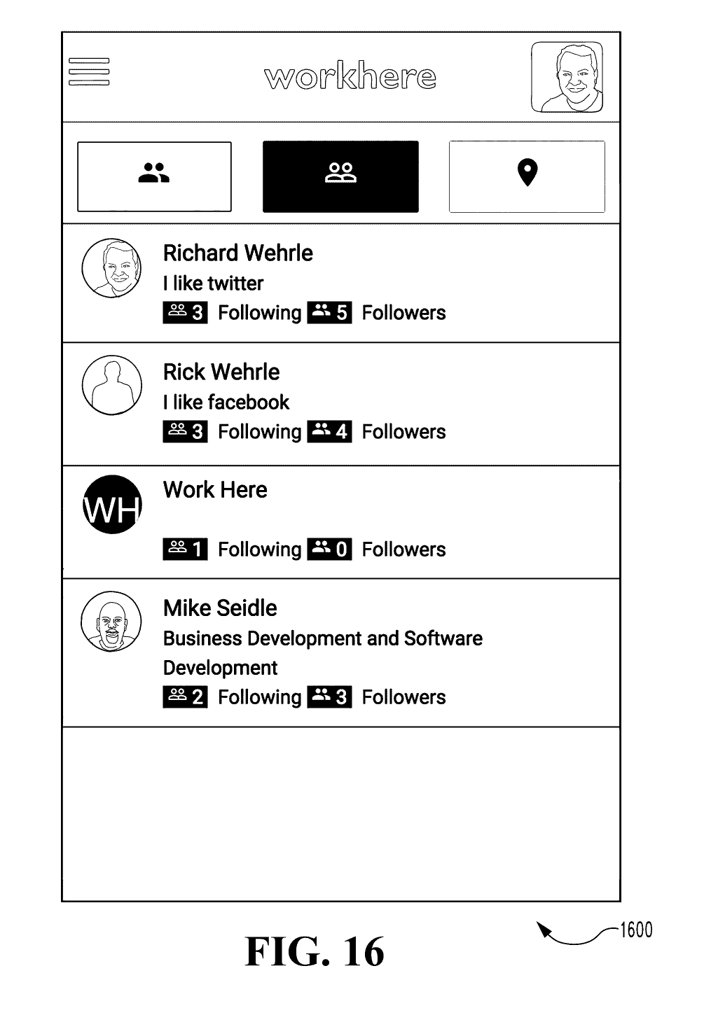

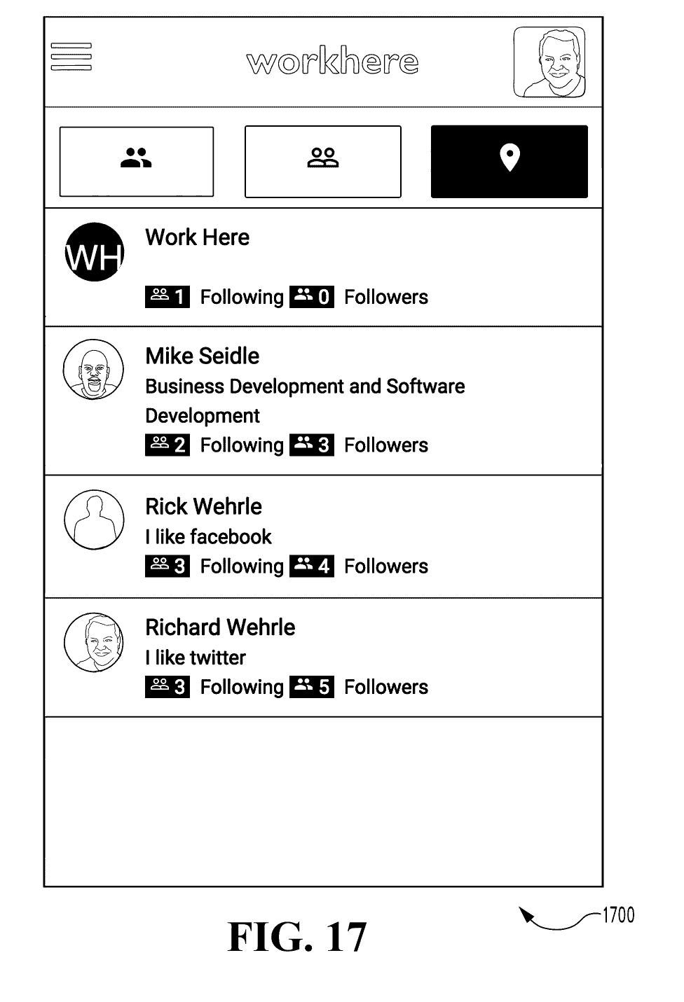

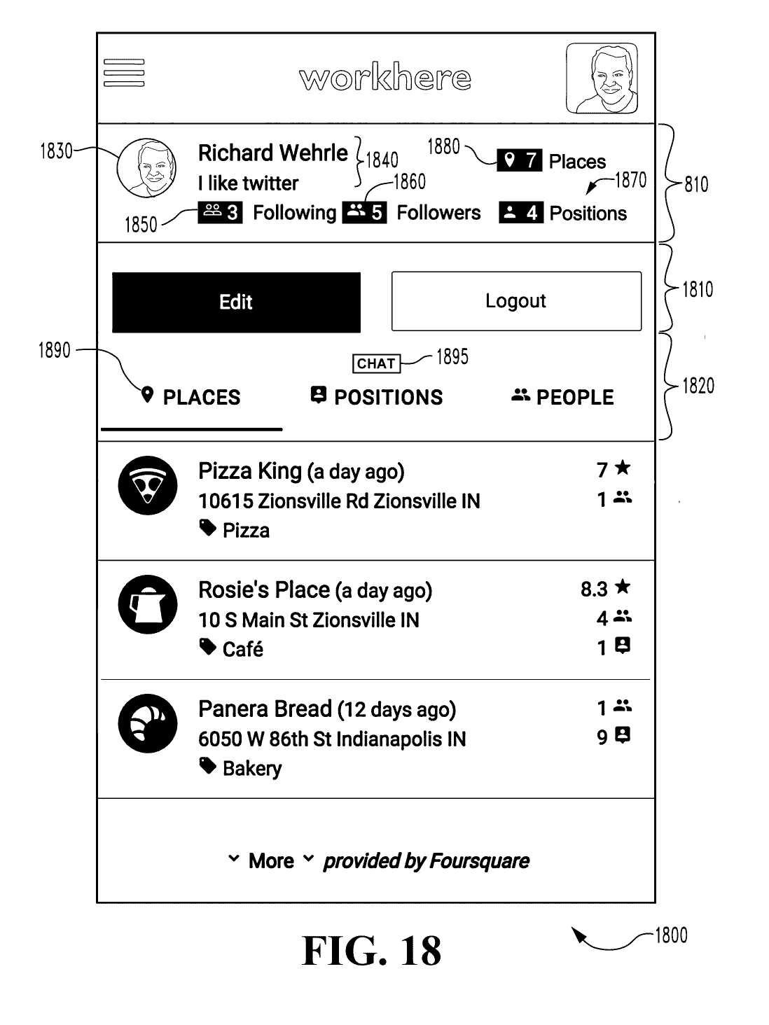

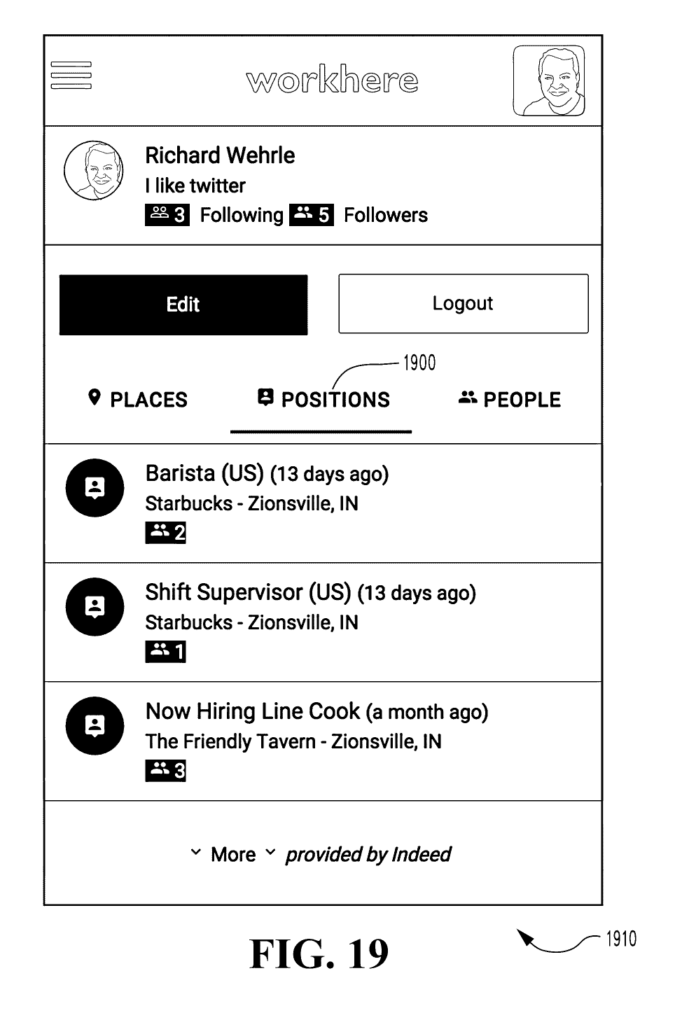

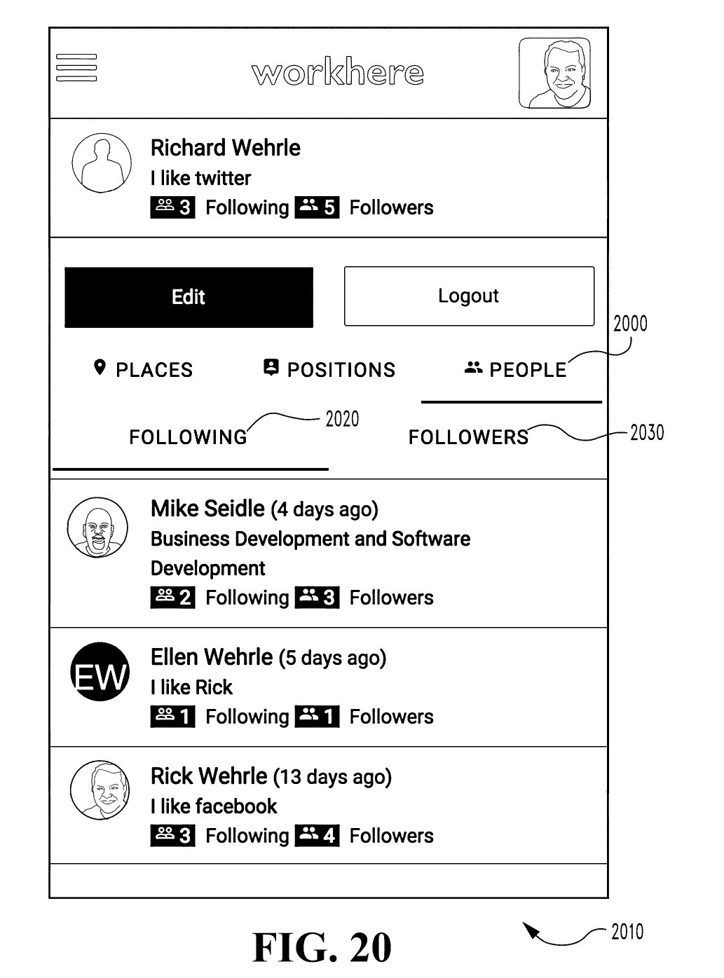

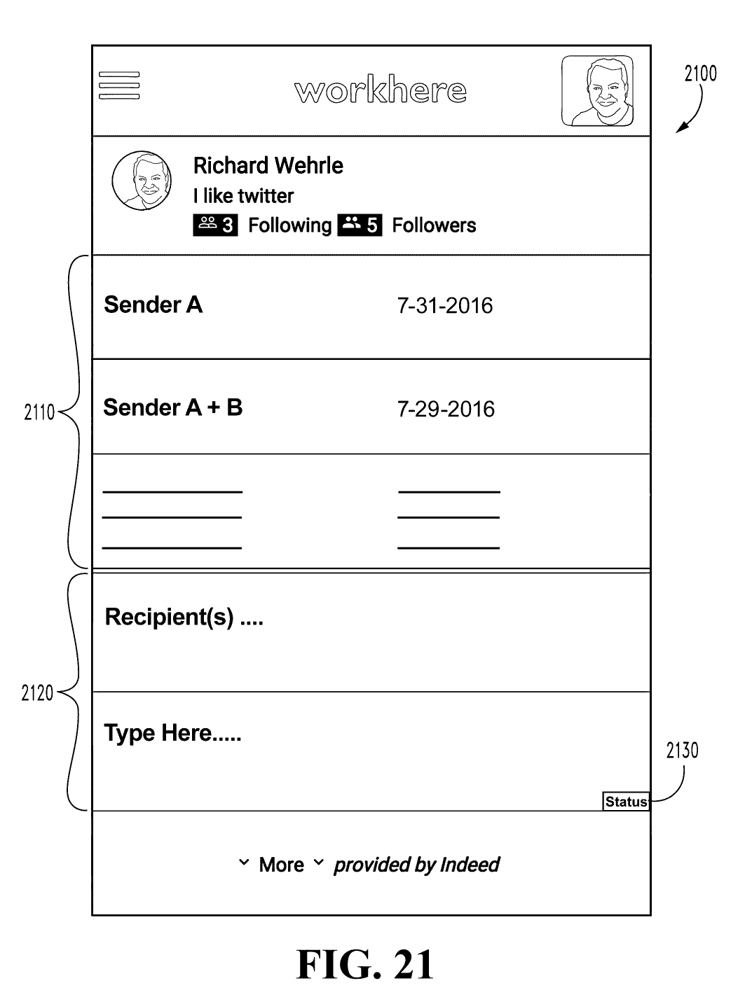

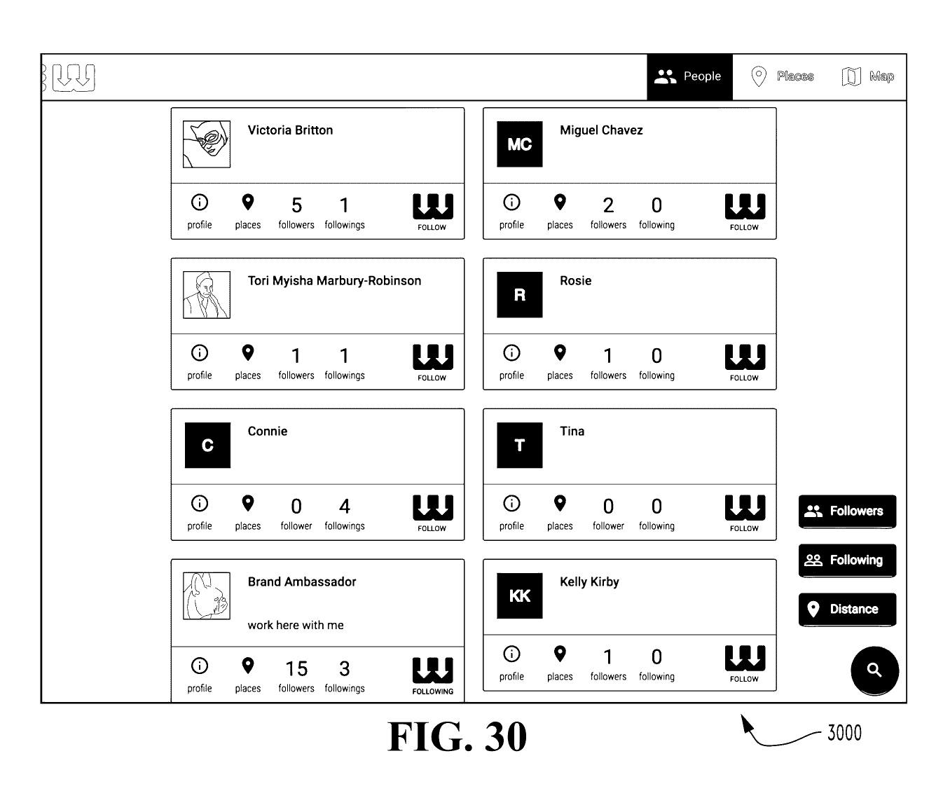

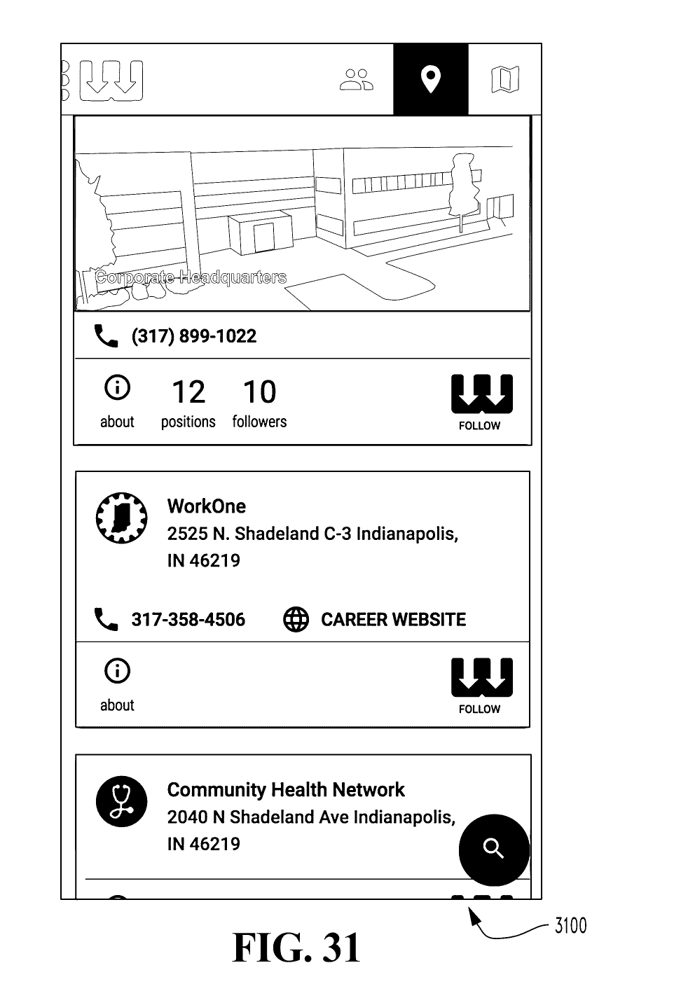

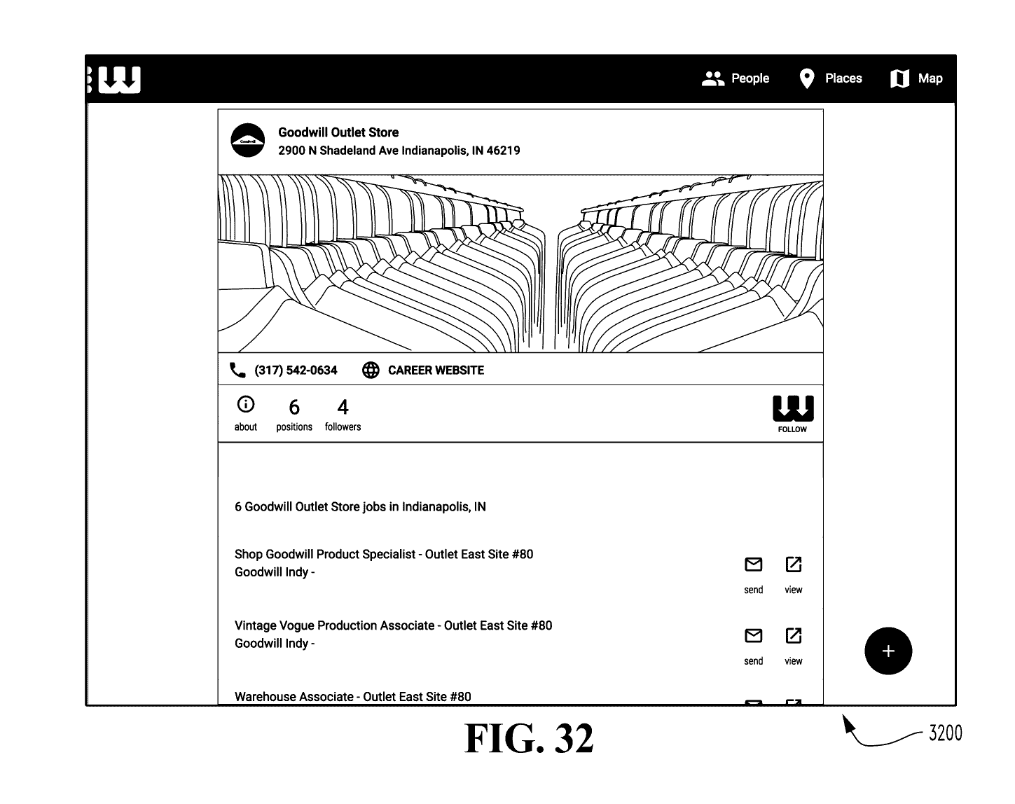

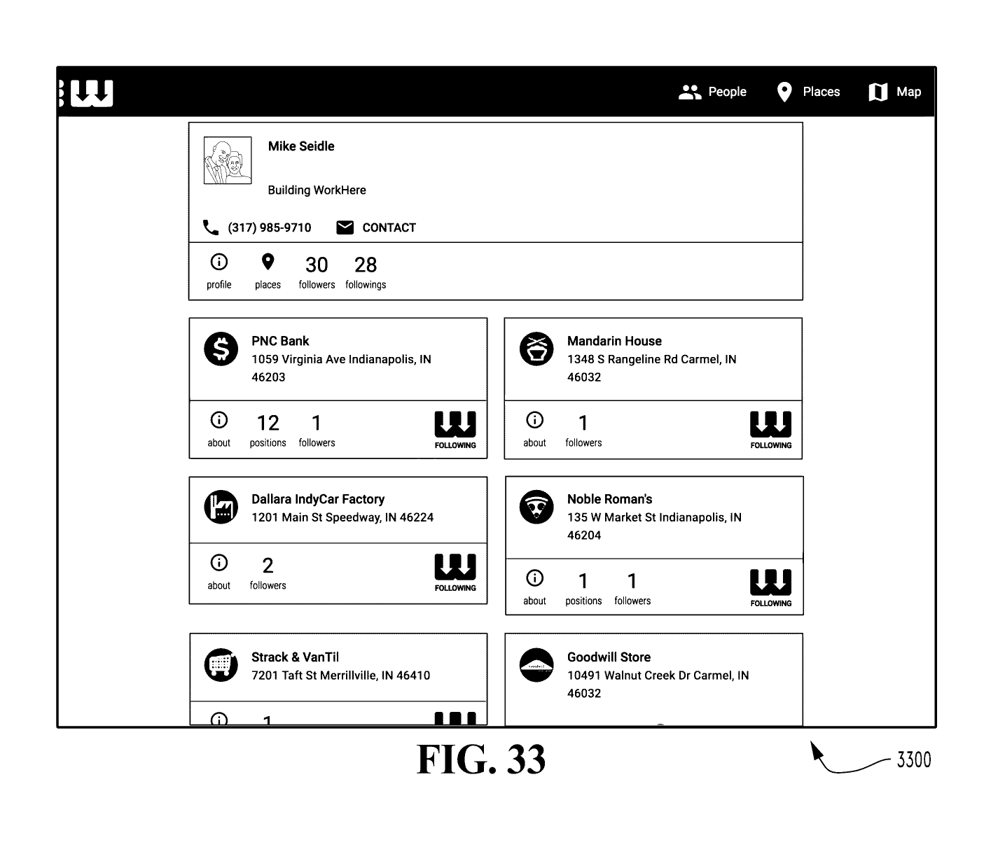

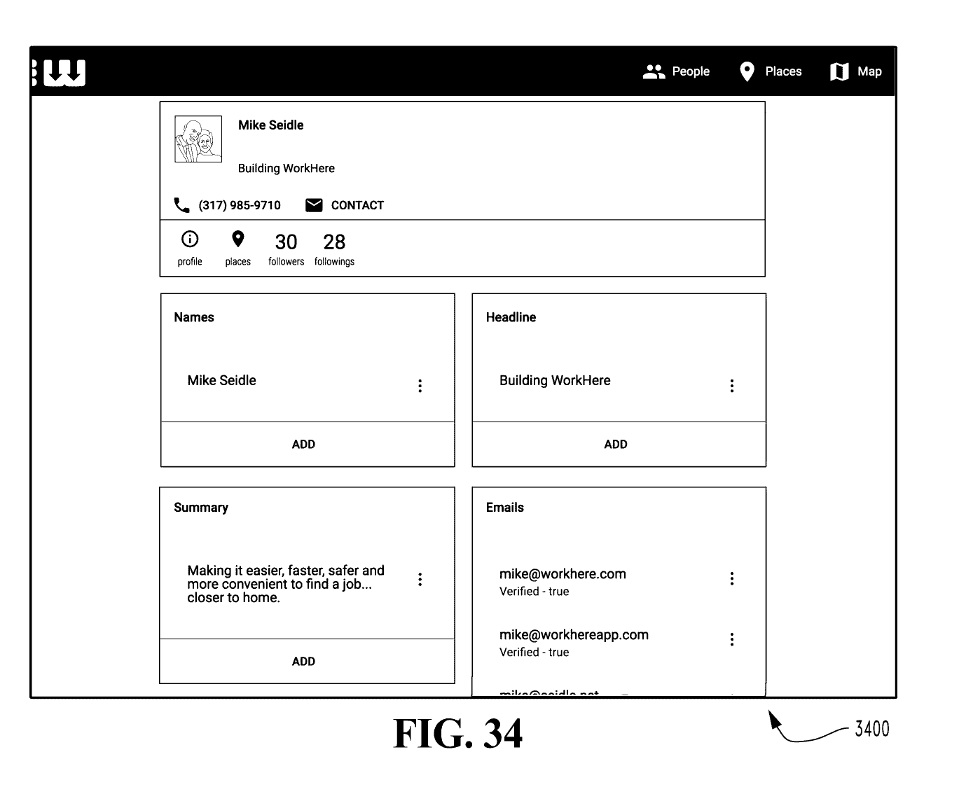

FIGS. 1-34 depict various aspects, views, and features of employee tracking system 105. FIG. 1 is a block diagram of an example environment 100 in which employment tracking system 105 may exist. Environment 100 may typically include employment tracking system 105; network 110; website(s) 115; end user device(s) 120; advertiser(s) 125; resource(s) 130; search system 135; search index 140; queries 145; search result(s) 150; marketplace apparatus 155; advertisement(s) 160; advertisement data store 165; and/or system database(s) 170. Employment tracking system 105 typically may facilitate tracking, searching, and/or offering employment between potential employees and employers. Example environment 100 also includes network 110, such as a local area network (LAN), a wide area network (WAN), the Internet, or a combination thereof. Network 110 may connect websites 115, end user device(s) 120, and/or employment tracking system 105. Example environment 100 may potentially include many thousands of website(s) 115 and/or end user device(s) 120.

Website(s) 115 may be one or more resources 130 associated with a domain name and hosted by one or more servers. An example website(s) 115 may be a collection of webpages formatted in hypertext markup language (HTML) that may contain text, images, multimedia content, and programming elements, such as scripts. Each website(s) 115 may be maintained by a publisher, which may be an entity that controls, manages, and/or owns each website(s) 115.

Resource(s) 130 may be any data that may be provided over the network 110. A resource(s) 130 may be identified by a resource address (e.g., a URL) that may be associated with the resource(s) 130. Resources 130 include HTML webpages, word processing documents, and portable document format (PDF) documents, images, video, and feed sources, to name only a few. Resources 130 may include content, such as words, phrases, images and sounds, that may include embedded information—such as meta-information in hyperlinks—and/or embedded instructions, such as JAVASCRIPT scripts (JAVASCRIPT is a registered trademark of Sun Microsystems, Inc., a Delaware corporation, located at 4150 Network Circle Santa Clara, Calif. 95054). Units of content—for example, data files, scripts, content files, or other digital data—that may be presented in (or with) resources may be referred to as content items.

End user devices 120 may be electronic devices that may be under the control of an end user and may be capable of requesting and receiving resources 130 over network 110. Example end user devices 120 include personal computers, mobile communication devices, and other devices that may send and receive data over the network 110. End user devices 120 typically include a user application, such as a web browser, to facilitate the sending and receiving of data over the network 110.

In some implementations, websites 115 (apps, client services; hereinafter simply “websites” for ease of use), end user devices 120, and system 105 may directly intercommunicate, excluding the need for the Internet from the scope of a network 110. For example, the websites 115, end user devices 120, and the employment tracking system 105 may directly communicate over device-to-device (D2D) communication protocols (e.g., WI-FI DIRECT (WI-FI DIRECT is a registered trademark of Wi-Fi Alliance, a California corporation, located at 10900-B Stonelake Boulevard, Suite 126, Austin, Tex. 78759); Long Term Evolution (LTE) D2D (LTE is a registered trademark of Institut Européen des Normes; a French nonprofit telecommunication association, located at 650 route des Lucioles, F-06921, Sophia Antipolis, France), LTE Advanced (LTE-A) D2D, etc.), wireless wide area networks, and/or satellite links thus eliminate the need for the network 110 entirely. In other implementations, the websites 115, end user devices 120, and system 105 may communicate indirectly to the exclusion of the Internet from the scope of the network 110 by communicating over wireless wide area networks and/or satellite links. Further, end user devices 120 may similarly send and receive search queries 145 and search results 150 indirectly or directly.

In wireless wide area networks, communication primarily occurs through the transmission of radio signals over analog, digital cellular, or personal communications service (PCS) networks. Signals may also be transmitted through microwaves and other electromagnetic waves. At the present time, most wireless data communication takes place across cellular systems using second generation technology such as code-division multiple access (CDMA), time division multiple access (TDMA), the Global System for Mobile Communications (GSM) (GSM is a registered trademark of GSM MoU Association, a Swiss association, located at Third Floor Block 2, Deansgrande Business Park, Deansgrande, Co Dublin, Ireland), Third Generation (wideband or 3G), Fourth Generation (broadband or 4G), personal digital cellular (PDC), or through packet-data technology over analog systems such as cellular digital packet data (CDPD) used on the Advance Mobile Phone System (AMPS).

The terms “wireless application protocol” and/or “WAP” mean a universal specification to facilitate the delivery and presentation of web-based data on handheld and mobile devices with small user interfaces. “Mobile Software” refers to the software operating system that allows for application programs to be implemented on a mobile device such as a mobile telephone or PDA. Examples of Mobile Software are JAVA and JAVA ME (JAVA and JAVA ME are trademarks of Sun Microsystems, Inc. of Santa Clara, Calif.), BREW (BREW is a registered trademark of Qualcomm Incorporated of San Diego, Calif.), WINDOWS Mobile (WINDOWS is a registered trademark of Microsoft Corporation of Redmond, Wash.), PALM OS (PALM is a registered trademark of Palm, Inc. of Sunnyvale, Calif.), SYMBIAN OS (SYMBIAN is a registered trademark of Symbian Software Limited Corporation of London, United Kingdom), GOOGLE ANDROID (GOOGLE and ANDROID are registered trademarks of Google, Inc. of Mountain View, Calif.), APPLE IPHONE OS (APPLE and IPHONE are registered trademarks of Apple, Inc. of Cupertino, Calif.), IOS (IOS is a registered trademark of Cisco Technology, Inc., a California corporation, located at 170 West Tasman Drive, San Jose, Calif.), and WINDOWS PHONE (WINDOWS PHONE is a registered trademark the Microsoft Corporation of Redmond, Wash.). “Mobile Apps” refers to software programs written for execution with Mobile Software.

The employment tracking system 105 may use one or more modules to perform various functions including, but not limited to, searching, analyzing, querying, interfacing, etc. A “module” refers to a portion of a computer system and/or software program that carries out one or more specific functions and may be used alone or combined with other modules of the same system or program. For example, a module may be located on the employment tracking system 105 (e.g., on the servers of system 105, i.e., server-side module), on end user devices 120, or on an intermediary device (e.g., the client server, i.e., a client-side module; another end user device(s) 120; a different server on the network 110; or any other machine capable of direct or indirect communication with system 105, websites 115, the search system 135, and/or the end user devices 120.)

In some implementations, the system 105 may be performed through a system 105 module. For example, a user may install a program to interface with a system 105 server to communicate data, interactions, and system 105 data to the user's end user device(s) 120. In some other implementations, the system 105 may be installed on a user's machine and operate—in whole or in part—independently of system 105 WAN and/or LAN components. For example, the system 105 software may be deployed to a user's computer as a standalone program. In another example, the system 105 may interact with and/or be installed as an Internet browser extension. For example, the system 105 may be a program installed as an extension, add-on, and/or plugin of GOOGLE CHROME (GOOGLE and CHROME are registered trademarks of Google, Inc., a Delaware corporation, located at 1600 Amphitheatre Parkway, Mountain View, Calif. 94043); MOZILLA FIREFOX (MOZILLA and FIREFOX are registered trademarks of the Mozilla Foundation, a California non-profit corporation, located at 313 East Evelyn Avenue, Mountain View, Calif. 94041); APPLE SAFARI (APPLE and SAFARI are registered trademarks of Apple, Inc., a California corporation, located at 1 Infinite Loop, Cupertino, Calif. 95014), etc. In some implementations, the browser extension may query an entered position 900 or location, check for open positions 900, query system 105 for updates to preferred position 900 openings, query system 105 for updates to placement postings, generate notifications (e.g., popups, text messages, emails, etc.) automatically and/or according to configured guidelines, and/or the like.

Typically, modules may be coded in JAVASCRIPT, PHP, or HTML, but may be created using any known programming language (e.g., BASIC, FORTRAN, C, C++, C#, PERL (PERL is a registered trademark of Yet Another Society DBA The Perl Foundation, a Michigan nonprofit corporation, located at 340 S. Lemon Ave. #6055, Walnut, Calif. 91789)) and/or package (e.g., compressed file (e.g., zip, gzip, 7zip, RAR (RAR is a registered trademark of Alexander Roshal, an individual, located in the Russian Federation AlgoComp Ltd., Kosareva 52b-83, Chelyabinsk, Russian Federation 454106), etc.), executable, etc.).

In some implementations, the employment tracking system 105 may be packaged, distributed, scripted, installed by a technician of system 105, and/or otherwise deployed to a client server location such that system 105 exists within the client server and/or client server network, either in whole or in part. For example, the employment tracking system 105 may be scripted and/or packaged into an executable package and downloaded by a client administrator; the client administrator then installing system 105 software package(s) onto the client server(s). Such setups may allow the employment tracking system 105 to operate all system 105 operations entirely within the client server(s) and/or client network, excluding the need to interface with system 105 provider's servers for some or all system 105 functions. Such an implementation may, for example, be used to reduce bandwidth, latency, complexity of network management, etc. In some other implementations, the client servers may facilitate only some of system 105 functions and interface with system 105 servers (over a network or directly) to enable those remaining functions. Still other implementations may link to system 105 servers to obtain updates, patches, and/or other modifications to system 105 distributions.

Employment tracking system 105 software distributions may, in some implementations, be installed in a virtual environment (e.g., HYPER-V (HYPER-V is a registered trademark of Microsoft, a Washington Corporation, located at One Microsoft Way, Redmond, Wash. 98052); VIRTUALBOX (VIRTUALBOX is a registered trademark of Oracle America, Inc., a Delaware corporation, located at 500 Oracle Parkway, Redwood Shores, Calif. 94065); VMWARE (VMWARE is a registered trademark of VMWare, Inc., a Delaware corporation, located at 3401 Hillview Ave., Palo Alto, Calif. 94304), etc.).

In other implementations, employment tracking system 105 software may be installed in whole or in part on an intermediary system that may be separate from the client and system 105 servers. For example, employment tracking system 105 software may be installed by an intermediary worker, a client worker, and/or a system 105 worker onto a hosting service (e.g., AMAZON WEB SERVICES (AWS) (AWS is a registered trademark of Amazon Technologies, Inc., a Nevada corporation, located at PO Box 8102, Reno, Nev. 89507), RACKSPACE (RACKSPACE is a registered trademark of Rackspace US, Inc., a Delaware corporation, located at 1 Fanatical Place, City of Windcrest, San Antonio, Tex. 78218), etc. The client may then connect to the intermediary and/or system 105 servers to access system 105 functions. Such implementations may, for example, allow distributed access, redundancy, decreased latency, etc.

End user device(s) 120 may request resources 130 from website(s) 115. In turn, data representing resource(s) 130 may be provided to end user device(s) 120 for presentation by end user device(s) 120. Data representing resource(s) 130 may also include data specifying a portion of the resource(s) 130 or a portion of a user display—for example, a small search text box or a presentation location of a pop-up window—in which advertisements or third-party search tools may be presented.

To facilitate searching of resource(s) 130, environment 100 may include a search system 135 that identifies resource(s) 130 by crawling and indexing resource(s) 130 provided by publishers on website(s) 115. Data about resource(s) 130 may be indexed based on resource(s) 130 to which the data corresponds. The indexed and, optionally, cached copies of resource(s) 130 may be stored in, for example, search index 140.

End user device(s) 120 may submit search queries 145 to search system 135 over network 110. In response, search system 135 accesses search index 140 to identify resource(s) 130 that may be relevant to search query 145. Search system 135 identifies the resources 130 in the form of search result(s) 150 and returns the search result(s) 150 to end user devices 120 in search results webpages. A search result(s) 150 may be data generated by the search system 135 that identifies a resource(s) 130 that may be responsive to a particular search query, and includes a link to the resource(s) 130. An example search result(s) 150 may include a webpage title, a snippet of text or a portion of an image extracted from the webpage, and the URL of the webpage.

Users that may be interested in a particular subject may perform a search by submitting one or more queries 145 to search system 135 in an effort to identify related information. For example, a user that may be interested sports may submit queries 145 such as “news,” “sports,” or “technology.” In response to each of these queries 145, the user may be provided search result(s) 150 that have been identified as responsive to the search query—that is, have at least a minimum threshold relevance to the search query, for example, based on cosine similarity measures or clustering techniques. The user may then select one or more of the search result(s) 150 to request presentation of a webpage or other resource(s) 130 that may be referenced by a URL associated with the search result(s) 150.

Other implementations of the employment tracking system 105 may allow for a game-like components, or gamification, aspect to interaction with system 105. For example, tangible (e.g., money, goods, etc.) and/or intangible (e.g., account badges, user name flair, etc.) rewards may be given to users who donate money to system 105, users voted most active on system 105, etc.

When search result(s) 150 are requested by an end user device(s) 120, the employment tracking system 105 may receive a request for data to be provided with the resource(s) 130 or search results 150. In response to the request, the employment tracking system 105 selects data that are determined to be relevant to the search query. In turn, the selected data are provided to the end user device(s) 120 for presentation with the search results 150.

For example, in response to the search query “restaurant,” system 105 may present the user with relevant food and/or restaurant-related results. If the user selects—for example, by clicking or touching—search result(s) 150, the end user device(s) 120 may be redirected, for example, to a webpage containing compiled restaurant reviews by diners. This webpage may include, for example, where to go on a date, what restaurants to eat at on vacations, etc.

In some implementations, the returned webpage may include all of the resources 130 that are required to complete a financial transaction for a service or product relevant to the employment tracking system 105. For example, the webpage may enable the user to add products to an electronic “shopping cart” and enter payment and/or shipping information. Some of these webpages may be secure webpages that protect the users' payment information and/or other sensitive information—for example, the user's address and name. Additionally, the website may include code that completes financial transactions—such as credit card transactions, online payment transactions, or other financial transactions.

In other implementations, the returned webpage may include code that references a marketplace apparatus 155 that is used to complete the transaction. The marketplace apparatus 155 is a data processing apparatus that is configured to facilitate sales transactions between buyers and sellers over the network 110. The marketplace apparatus 155 may be configured to provide electronic “shopping carts,” perform financial transactions, provide transaction confirmation data to the buyer and/or seller, and/or provide shipment-tracking information if the user purchases physical goods, such as artist or author merchandise.

For example, a webpage may include code that causes a checkout user interface element—for example, a checkout button—to be presented to the user. In response to the user clicking on the checkout user interface element, checkout data may be provided to the marketplace apparatus 155 indicating that the user is ready to agree to an exchange or complete a purchase. The checkout data may include product identifiers specifying the products that the user has selected to purchase, quantities of each product that the user has selected to purchase, and prices associated with the selected products. These identifiers may be in addition to terms of the exchange or included within the terms of the exchange. In response to receipt of the checkout data, the marketplace apparatus 155 may provide the user with a transaction interface that enables the user to submit payment information and shipping information to complete the transaction. Once the transaction is complete, the marketplace apparatus 155 may provide the user with confirmation data confirming the details of the transaction.

The payment interface that is provided by the marketplace apparatus 155 may be accessed by the user at a secure network location that is referenced by a URL. The URL may be formatted to include data identifying a referring webpage from which the user navigated to the payment interface. For example, the URL that directs a user to the payment interface may be https://www.examplepaymentinterface.com/˜id1234/PartnerA.com, where “id1234” is a unique identifier for Partner A, and PartnerA.com is the domain address for Partner A's website.

The employment tracking system 105 may also make use of advertisements 160 based on user actions on the website. As a user makes search queries 145 and receives search results 150, the user's activities may be represented in the search index 140 with a session identifier. This session identifier may be the user's Internet Protocol (IP) address, unique browser identifier, or any other similar identifier. Based on the user's interactions and intent, the system 105 may display advertisements 160 from advertisers 125 that target the user's interactions. The determination of relevance based on the user's interactions may also be based upon historical data stored in the advertisement data store 165.

In some implementations, the advertisement data store 165 may also store user interaction data specifying user interactions with presented advertisements (or other content items). For example, when an advertisement is presented to the user, data may be stored in the advertisement data store 165 representing the advertisement impression. Further, in some implementations, the data is stored in response to a request for the advertisement that is presented. For example, the ad request may include data identifying a particular cookie, such that data identifying the cookie may be stored in association with data that identifies the advertisement(s) that was or were presented in response to the request.

When a user selects—for example, clicks or touches—a presented advertisement, data is stored in the advertisement data store 165 representing the user selection of the advertisement. In some implementations, the data may be stored in response to a request for a webpage that is linked to by the advertisement. For example, the user selection of the advertisement may initiate a request for presentation of a webpage that is provided by (or for) the advertiser. The request may include data identifying the particular cookie for the user device, and this data may be stored in the advertisement data store 165. Additionally, if an advertiser has opted-in to have click-through traffic tracked, when a user performs an action that the user has defined as a click-through, data representing the click-through may be provided to the employment tracking system 105 and/or stored in the advertisement data store 165.

In some implementations, user interaction data that are stored in the advertisement data store 165 may be anonymized to protect the identity of the user with which the user interaction data is associated. For example, user identifiers may be removed from the user interaction data. Alternatively, the user interaction data may be associated with a hash value of the user identifier to anonymize the user identifier. In some implementations, user interaction data are only stored for users that opt-in to having user interaction data stored. For example, a user may be provided an opt-in/opt-out user interface that allows the user to specify whether they approve storage of data representing their interactions with content.

When the employment tracking system 105 and the search system 135 are operated by a same entity, user interaction data may be obtained by the employment tracking system 105 in a manner similar to that described above. For example, a cookie may be placed on the user device by the search system 135, and the user interactions may be provided to the employment tracking system 105 using the cookie.

When the employment tracking system 105 and the search system 135 are operated by different entities that do not share user interaction data as described above, the employment tracking system 105 may utilize other data collection techniques to obtain user interaction data. For example, the employment tracking system 105 may obtain user interaction data from users that have agreed to have interactions tracked—that is, he or she opted-in. Users may opt-in, for example, to increase the relevance of content items and other information that are provided to the users, or to obtain a specified benefit such as use of an application or to obtain discounts for other services. As described above, the user interaction data obtained from these users may also be anonymized in order to protect the privacy of the users that opt-in. This user interaction data may also be stored in the advertisement data store 165.

The environment 100 may also include a system database(s) 170 to receive and record information regarding the employment tracking system 105, website(s) 115, end user devices 120, and/or any other data useful to environment 100. For example, information regarding end user devices 120 and end user identifiers may be stored and analyzed to determine user activity on website(s) 115 and/or system 105.

In some implementations, data that may be stored in the system database(s) 170 may be anonymized to protect the identity of the user with which the user data may be associated. For example, user identifiers may be removed from the user data to provide to third-party clients. Alternatively, the user data may be associated with a hash value of the user identifier to anonymize the user identifier. In some implementations, data are only stored for users that opt-in to having their data stored. For example, a user may be provided an opt-in/opt-out user interface that allows the user to specify whether they approve storage of data associated with the user.

While system 105 may operate with only one of each component (e.g., one system 105, one website 115, one end user, one end user device 120, etc.), system 105 may be benefitted by multiple of these components (and/or in some instances greatly benefitted by a mass amount of said components). For example, the existence and activity of a plurality of users on system 105 may foster greater creativity and flexibility of feedback to system 105 as compared to creative and intellectual stagnation that may typically occur with a small user base. Additionally, features such as game-like interaction of system 105 may be difficult or impossible without at least a small plurality of active competitors on system 105; however, as the number of active users increases, the likelihood of a successful ecosystem for the game-like system 105 features also increases and may tend to lead to greater success of system 105 and user activity (quantity and quality) compared to a small user base.

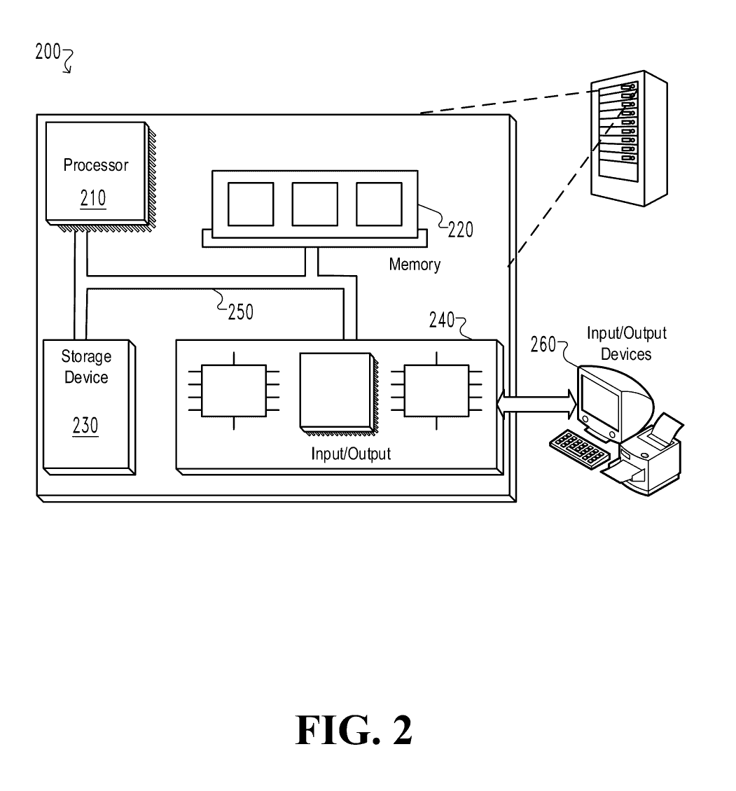

FIG. 2 is a block diagram of an example computer system 200 that may be used to provide employment tracking system 100, as described above. The system 200 may typically include processor(s) 210; memory 220; storage device(s) 230; system input(s)/output(s) 240; system bus(es) 250; and input/output device(s) 260. Each of the components 210, 220, 230, and 240 typically may be interconnected, for example, using system bus(es) 250. Processor(s) 210 may be capable of processing instructions for execution within the system 200. In one implementation, processor(s) 210 may be a single-threaded processor. In another implementation, processor(s) 210 may be a multi-threaded processor. In yet another implementation, processor(s) 210 may be a single-core processor, a multiple-core processor, and/or multiple processors (i.e., more than one socketed processor). Processor(s) 210 typically may be capable of processing instructions stored in the memory 220 and/or on the storage device(s) 230.

Memory 220 stores information within system 200. In one implementation, memory 220 may be a computer-readable medium. In one other implementation, memory 220 may be a volatile memory unit. In another implementation, memory 220 may be a nonvolatile memory unit.

Storage device(s) 230 may be capable of providing mass storage for the system 200. In one implementation, storage device(s) 230 may be a computer-readable medium. In various different implementations, storage device(s) 230 may include, for example, a hard disk device, a solid-state disk device, an optical disk device, and/or some other large capacity storage device.

System input(s)/output(s) 240 provide input/output operations for the system 200. In one implementation, system input(s)/output(s) 240 may include one or more network interface devices, for example an Ethernet card; a serial communication device, for example an RS-232 port; and/or a wireless interface device, for example an IEEE 802.11 card. In another implementation, system input(s)/output(s) 240 may include driver devices configured to receive input data and send output data to other input/output device(s) 260, for example keyboards, printers, display devices, and/or any other input/output device(s) 260. Other implementations, however, may also be used, such as mobile computing devices, mobile communication devices, set-top box television client devices, etc.

Although an example processing system has been described in FIG. 1, implementations of the subject matter and the functional operations described in this specification may be implemented in other types of digital electronic circuitry, or in computer software, firmware, or hardware, including the structures disclosed in this specification and their structural equivalents, or in combinations of one or more of them.

Embodiments of the subject matter and the operations described in this specification may be implemented as a method, in digital electronic circuitry, or in computer software, firmware, or hardware, including the structures disclosed in this specification and their structural equivalents, or in combinations of one or more of them. Embodiments of the subject matter described in this specification may be implemented as one or more computer programs—that is, one or more modules of computer program instructions encoded on computer storage medium for execution by, or to control the operation of, data processing apparatus. Alternatively, or in addition, the program instructions may be encoded on an artificially-generated propagated signal, for example a machine-generated electrical, optical, or electromagnetic signal, which may be generated to encode information for transmission to suitable receiver apparatus for execution by a data processing apparatus. A computer storage medium may be, or be included in, a computer-readable storage device, a computer-readable storage substrate, a random or serial access memory array or device, or a combination of one or more of them. Moreover, while a computer storage medium may not be a propagated signal, a computer storage medium may be a source or destination of computer program instructions encoded in an artificially-generated propagated signal. The computer storage medium may also be, or be included in, one or more separate physical components or media (e.g., multiple CDs, disks, or other storage devices).

The operations described in this specification may be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus may include special purpose logic circuitry, for example an field programmable gate array (FPGA) or an application-specific integrated circuit (ASIC). The apparatus may also include, in addition to hardware, code that creates an execution environment for the computer program in question, for example code that constitutes processor firmware, a protocol stack, a database management system, an operating system, a cross-platform runtime environment, a virtual machine, or a combination of one or more of them. The apparatus and execution environment may realize various different computing model infrastructures, such as web services, distributed computing, and grid computing infrastructures.

A computer program (also known as a program, software, software application, script, or code) may be written in any form of programming language, including compiled or interpreted languages, declarative or procedural languages, and it may be deployed in any form, including as a stand-alone program or as a module, component, subroutine, object, or other unit suitable for use in a computing environment. A computer program can, but need not, correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform actions by operating on input data and generating output. The processes and logic flows may also be performed by, and apparatus may also be implemented as, special purpose logic circuitry, for example an FPGA or an ASIC.

Processors suitable for the execution of a computer program include, by way of example, both general and special purpose microprocessors, and any one or more processors of any kind of digital computer. Typically, a processor may receive instructions and data from a read-only memory or a random access memory or both. The essential elements of a computer are a processor for performing actions in accordance with instructions and one or more memory devices for storing instructions and data. Typically, a computer may also include, or be operatively coupled to receive data from or transfer data to, or both, one or more mass storage devices for storing data, e.g., magnetic, magneto-optical disks, or optical disks. However, a computer need not have such devices. Moreover, a computer may be embedded in another device, for example a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, for example erasable programmable read-only memory (EPROM), electrically erasable programmable read-only memory (EEPROM), and/or flash memory devices; magnetic disks, for example internal hard disks or removable disks; magneto-optical disks; and/or compact disk read-only memory (CD-ROM) and digital video disk real-only memory (DVD-ROM) disks. The processor and the memory may be supplemented by, or incorporated in, special purpose logic circuitry.

To provide for interaction with a user, embodiments of the subject matter described in this specification may be implemented on a computer having a display device (e.g., a cathode ray tube (CRT), liquid crystal display (LCD), or organic light-emitting diode (OLED) monitor), for displaying information to the user and a keyboard and a pointing device, e.g., a mouse or a trackball, by which the user may provide input to the computer. These may, for example, be desktop computers, laptop computers, smart TVs, etc. Other mechanisms of input may include portable and or console entertainment systems such as GAME BOY and/or NINTENDO DS ((GAME BOY, GAME BOY COLOR, GAME BOY ADVANCE, NINTENDO DS, NINTENDO 2DS, and NINTENDO 3DS are registered trademarks of Nintendo of America Inc., a Washington corporation, located at 4600 150th Avenue NE, Redmond, Wash. 98052), IPOD (IPOD is a registered trademark of Apple Inc., a California corporation, located at 1 Infinite Loop, Cupertino, Calif. 95014), XBOX (e.g., XBOX, XBOX ONE) (XBOX and XBOX ONE are registered trademarks of Microsoft, a Washington corporation, located at One Microsoft Way, Redmond, Wash. 98052), PLAYSTATION (e.g., PLAYSTATION, PLAYSTATION 2, PS3, PS4, PLAYSTATION VITA) (PLAYSTATION, PLAYSTATION 2, PS3, PS4, and PLAYSTATION VITA are registered trademarks of Kabushiki Kaisha Sony Computer Entertainment TA, Sony Computer Entertainment Inc., a Japanese corporation, located at 1-7-1 Konan Minato-ku, Tokyo, 108-0075, Japan), OUYA (OUYA is a registered trademark of Ouya Inc., a Delaware corporation, located at 12243 Shetland Lane, Los Angeles, Calif. 90949), WII (e.g., WII, WII U) (WII and WII U are registered trademarks of Nintendo of America Inc., a Washington corporation, located at 4600 150th Avenue NE, Redmond, Wash. 98052), etc.

Other kinds of devices may be used to provide for interaction with a user as well; for example, feedback provided to the user may be any form of sensory feedback, for example visual feedback, auditory feedback, or tactile feedback; and input from the user may be received in any form, including acoustic, speech, or tactile input. In addition, a computer may interact with a user by sending documents to and receiving documents from a device that may be used by the user; for example, by sending webpages to a web browser on a user's client device in response to requests received from the web browser.

Some embodiments of the subject matter described in this specification may be implemented in a computing system 200 that includes a back-end component (e.g., a data server,) or that includes a middleware component (e.g., an application server,) or that includes a front-end component (e.g., a client computer having a graphical user interface or a Web browser through which a user may interact with an implementation of the subject matter described in this specification,) or any combination of one or more such back-end, middleware, or front-end components. The components of the computing system 200 may be interconnected by any form or medium of digital data communication, for example a communication network. Examples of communication networks include a local area network (LAN) and a wide area network (WAN), an inter-network (e.g., the Internet), and peer-to-peer networks (e.g., ad-hoc peer-to-peer, direct peer-to-peer, decentralized peer-to-peer, centralized peer-to-peer, etc.).

The computing system 200 may include clients, including but not limited to end user devices 120, and servers, including but not limited to system 105. A client and server are typically remote from each other and typically interact through a communication network 110. The relationship of client and server typically arises by virtue of computer programs running on the respective computers and having a client-server relationship to each other. In some embodiments, a server transmits data (e.g., an HTML webpage) to a client device (e.g., for purposes of displaying data to and receiving user input from a user interacting with the client device). Data generated at the client device (e.g., a result of the user interaction) may be received from the client device at the server.

Employment tracking system 105 may typically be discussed according to the following general definitions; however, the following general definitions are meant to be instructive and not limiting. As such, the following definitions typically may help guide understanding of the following system 105 descriptions, but there may obviously be examples and implementations in which the general definitions are modified, reversed, repeated, and/or otherwise altered.

An application programming interface (API) typically may be a means for a software application to communicate directly and/or indirectly with one or more software applications.

An app typically may be an abbreviation of application.

An avatar typically may be a graphical representation of a user within an interface of system 105, typically inside either a square or circular icon. For example, a default avatar icon typically may display the initials of a user. In some implementations, an option typically may be provided to replace the initials of the user with a photo of the user from an existing social network account.

Cascading style sheets (CSS) typically may be a style sheet language used for describing the look and formatting of a document written in a markup language, for example hypertext markup language (HTML). CSS may, for example, be used to implement websites 115.

A collection typically may be a grouping of database documents, including but not limited to database documents such as those of MongoDB (MONGODB is a registered trademark of Mongodb, Inc., a Delaware corporation, located at 229 West 43^{rd} Street, 5^{th} Floor, New York, N.Y. 10036), but other database platforms may be used. Collections may, for example, be contained on system databases 170. In some implementations, a collection typically may be the equivalent of a relational database table. In some other implementations, a collection typically may exist within a single database, while in other implementations, a collection may exist within one or more databases. Typically, collections may not enforce a schema, and documents within a collection may have different fields. Typically, documents in a collection may have a similar and/or related purpose, while in other implementations, documents may be uniquely purposed.

A customer typically may be a user who purchases services from system 105. A customer typically may operate end user devices 120.

A document typically may be one, but sometimes more than one, record from the database (e.g., system databases 170).

An evergreen position typically may refer to an employment opportunity that is always, or almost always, advertised, even when there is not currently an available opening or job vacancy. As a function of high turnover and seasonality, many employers typically may be always hiring for most positions 900 and may utilize evergreen ads to build a talent pipeline of potential employees.

A hyper local talent community (HLTC) may typically be a collection of individuals who typically live nearby or have indicated interest in a place and/or job.

In-app messages may typically be one or more notifications displayed while a user typically may be active within the app, which may create a structured process and prolongs session time. This form of messaging typically may be highly contextual and/or rooted in analytics, and may be triggered based on user interactions.

A mobile application (also referred to as a mobile app) may typically be software that may be installed and run on an IOS, ANDROID, or any other operating system-powered tablet, phone, media player, GPS device, digital camera, and/or other device. For example, a mobile application may be software that may operate on a smartphone, laptop, and/or desktop computer. Derivatives (e.g., FIRE OS (FIRE is a registered trademark of Amazon Technologies, Inc., a Nevada corporation, located at 410 Terry Ave N, Washington 98109), which is built on ANDROID) may be considered to be effectively the same as their source (e.g., ANDROID).

Over-the-top (OTT) messaging typically refers to providing instant messaging services as an alternative to text messaging services provided by a mobile network operator. Examples typically include, but are not limited to, new chat apps like SLACK (SLACK is a registered trademark of Slack Technologies, Inc., a Delaware corporation, located at 6th Floor 155 Fifth Street, San Francisco, Calif. 94103), WHATSAPP (WHATSAPP is a registered trademark of WHATSAPP Inc., a Delaware corporation, located at 650 Castro Street, Suite 120-219, Mountain View, Calif. 94041), and FACEBOOK MESSENGER (FACEBOOK and MESSENGER are registered trademarks of Facebook, Inc., a Delaware corporation, located at 1601 Willow Road, Menlo Park, Calif. 94025).

A place may typically be a geographic and/or symbolic location, and/or collection of locations with a common name, such as a region (e.g., Broad Ripple).

A places API may typically be a web service that typically provides information on places based on geographic data provided.

A position 900 typically may be a general occupation category or type of job, often simplified as a lay title. Nonexclusive examples of position 900 lay titles may be cashier, cook, and/or server.

A profile may typically be detailed information provided by a user including his or her avatar, name, tagline, address, phone number, email, and/or other identifying and/or differentiating information.

A public profile may typically be the part of a profile that typically may be visible to the general public.

A push message may typically be a message sent directly to a mobile device's system message API from an application server. Push messages may typically appear as “tray notifications” on ANDROID and as “notifications” on IOS-powered devices. Great for prompting immediate interaction and engaging users not currently active in the app, push messaging directs attention to a desired action. Users who opt-in for push notifications typically may be a high-value demographic, as they tend to be more engaged with the app on a regular basis. Push messaging typically may have three key considerations: content, frequency, and timing.

Short message service (SMS) typically may be a text messaging service component of phone, Internet, and/or mobile communication systems. It typically may use standardized communications protocols to allow fixed line and/or mobile phone devices to exchange short text messages.

Two-way follow typically occurs when a first user typically may be following a second user and that second user typically may be following the first user. Effectively, two-way follow typically represents a reciprocal user interaction relationship.

A user may typically be a person who typically may be using the system 105 app.

Web application (also referred to as web app) may typically be software that typically runs in a web browser, regardless of the mobility of the device.

A system app typically may refer to both the mobile app and/or web app associated with system 105.

As a general overview of system 105, system 105 typically may generate revenue by selling subscriptions to businesses, business owners, place managers, recruiting contractors, and advertisers that get access to users who follow their places 320, positions 900, and people.

Users typically may be customers when they (1) claim a place by paying a monthly subscription fee for one or more places; (2) buy advertising; (3) purchase data and analytical services; (4) purchase geofenced messaging packs; pay for customization of their places; (5) pay for integration to other systems; (6) pay for other professional services; and/or the like.

System 105 typically consists of software that runs on one or more Internet-connected servers and typically may be displayed on end user devices 120, typically as a website 115 and/or mobile application. FIG. 1, described above, describes such an example environment 100. A further defined implementation of system 105 may be established as follows:

The server application may typically consist of a database server (e.g., NoSQL, MongoDB, Redis, CouchDB, Notes, etc.) and additional code (e.g., JAVASCRIPT, PHP, etc.) that implements server-side logic. The client application typically consists of database software (e.g., minimongo, PouchDB, etc.) that replicates the API of the database and/or database server; HTML and CSS code used to format and display various views for generation to user devices 120; and additional code (e.g., JAVASCRIPT, PHP, etc.) that implements client-side logic.

Data on system 105 typically may be moved from the client (e.g., end user devices 120) to the server (e.g., system 105) and vice versa by observing changes in database (e.g., system databases 170) state and sending changes to the server or client as appropriate. In some implementations, this exchange may be synchronous; while in other implementations, this exchange may be asynchronous; and in still further, the exchanges may be both synchronous and asynchronous.

Application logic may be run on the client or server as security and integration needs dictate. For example, code that requests data from one or more location services, including but not limited to FOURSQUARE (FOURSQUARE is a registered trademark of Foursquare Labs, Inc., a Delaware corporation, located at 568 Broadway, 10th Floor, New York, N.Y. 10012), GOOGLE Maps, and/or the like, may receive that data and load it into the database, which may run on the server. In some implementations, geolocation code may run on the client side and identify a user's longitude and latitude based on the location detection mechanisms of a user device 120 and/or like device. In some further implementations, both server and/or client may trigger calls on the other device/system. For example, the geolocation code on the client may trigger a call to get more place results on the server.

Client software typically may be designed to allow the application to access features of either the web browser and/or mobile device. This allows system messages and location services on mobile devices, or browser notifications and navigator objects—typically a browser API that provides information about the operating system, hardware, and location—for getting user location on end user devices 120.

System 105 may typically represent system 105 user interactions as following statuses and relationships. System 105 typically may be based on a network of (1) people; (2) places 320 (e.g., a physical place (e.g., with an address, GPS coordinate, etc.), etc.); (3) positions 900 (e.g., a job opportunity, etc.); and/or (4) groups (e.g., a group of places 320, positions 900, and/or people). A neighborhood typically may be a group of places 320 and/or people; and/or a hyper local talent pipeline that typically may be a group of people, places 320, and/or positions 900.

People who claim a place on system 105, or typically may be invited to manage a place on system 105, may use system 105 as that place's management portal. The social network typically may be built by people following people, places 320, positions 900, and/or groups. When a two-way relationship exists between two users, those users typically may chat with each other, share contact information, share leads, share reviews, share private data, and/or the like.

When a person follows a group, place 320, or position 900, a number of events may occur. Typically, the place 320 gets access to the person's contact information, may directly message the person, may directly chat with the person, may display the person as a follower, and/or the like.

Similarly, the person gets access to the places contact information, may directly message the place, may directly chat with the place, may display the place on their places tab, and/or the like.

When a person follows a person, typically the person being followed may see their follower, and the person following may see public activity of the person they typically may be following.

When a two-way relationship occurs between people, typically both people may get access to each other's contact information and/or the two people may chat with one another.

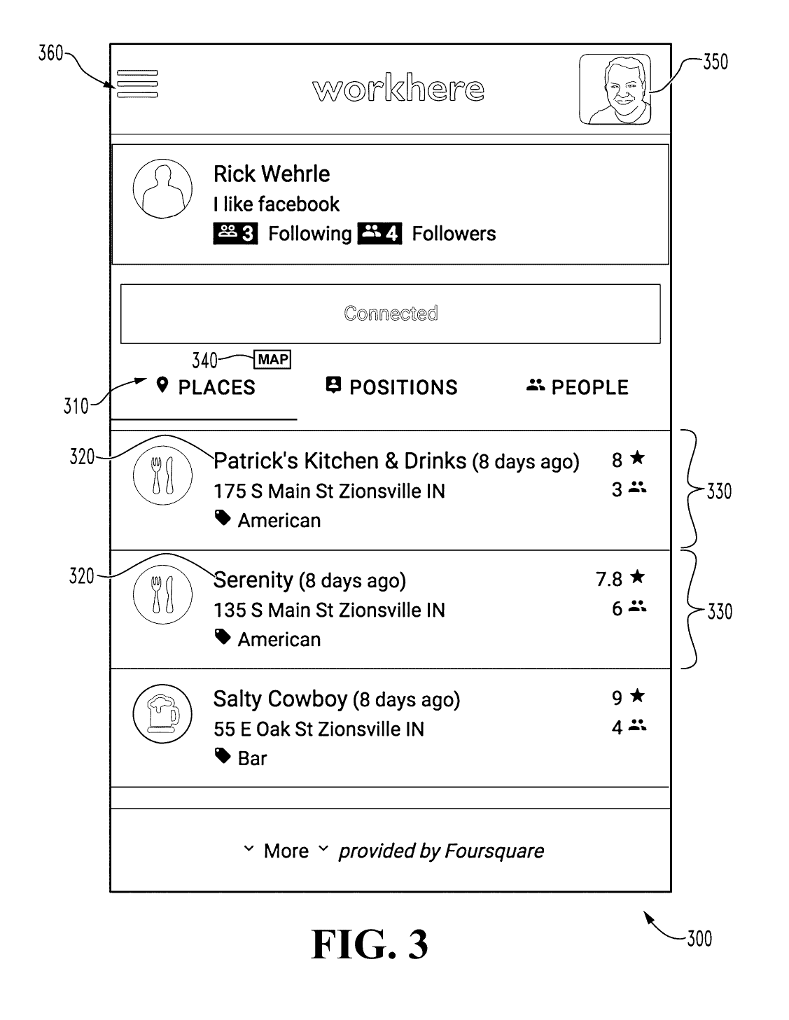

The user registration process flow may typically include steps of (1) a user may register for a user account by providing his or her email address and a password; (2) the user's email address typically may be confirmed by sending an email with a link that contains a unique token that typically may be clicked on by the user; (3) the user may then associate one or more third-party social accounts, such as FACEBOOK, FOURSQUARE, GOOGLE, TWIITER (TWIITER is a registered trademark of Twitter, Inc., a Delaware corporation, located at 1355 Market Street, Suite 900, San Francisco, Calif. 94103), and/or the like, with their user account; (4) the user completes their profile by confirming/editing/updating the required name and/or data fields; (5) the user typically may be then presented with instructional onboarding content, designed to familiarize them with how to use the app; and (6) the user typically then lands on the places view 300 (also referred to as places tab), which typically may be the default app navigation view for system 105. FIGS. 3-6 typically depict places view 300.

Typically, a user may claim a place 320 and become a customer of system 105 by (1) clicking a “claim place” button associated with a specific place; (2) user agrees to a subscription level for system 105 usage; (3) user chooses a payment method and package (typically, at this point the user becomes a customer and place owner); (4) user confirms and updates place profile; and (5) user confirms, adds, or updates positions 900 listed for each claimed place. In some implementations, user may select only one place, while in other implementations, user may select multiple places. For multiple places, system 105 typically queries the place API on system 105 for other locations with the same name, removes places already registered, and presents a list of places to claim to the user, and user selects places they want to claim.

System 105 graphical user interface (GUI) typically may be organized into five main navigation views: places view 300, map view 1000, positions view 1200, people view 1300, and profile view 1800 (also called person view and/or person detail view). In some implementations, one or more views may be nested within one or more other views. For example, map view 1000 may be nested within places view 300.

System 105's places view 300 typically may be accessed by clicking the map pin icon 310 in the main navigation screen (e.g., places view 300) of system 105's GUI. Typically, once entering and/or entered into places view 300, the browser and/or mobile device API on the end user device 120 sends the location of the current user to the server (e.g., system 105), which triggers the server to connect with a places API and retrieve nearby places 320. Places 320 received from the places API typically may be stored in the place collection associated with the place 320, and places 320 not already stored on the client typically may be sent to the client device 120. Further, user avatar 350 and menu icon 360 may provide additional navigation references and interface options.

Places view 300 typically may be generated to show a list of one or more place summary cards 330. Tapping on a place summary card 330 may typically direct the user to the place detail view 700 corresponding to that place summary card 330.

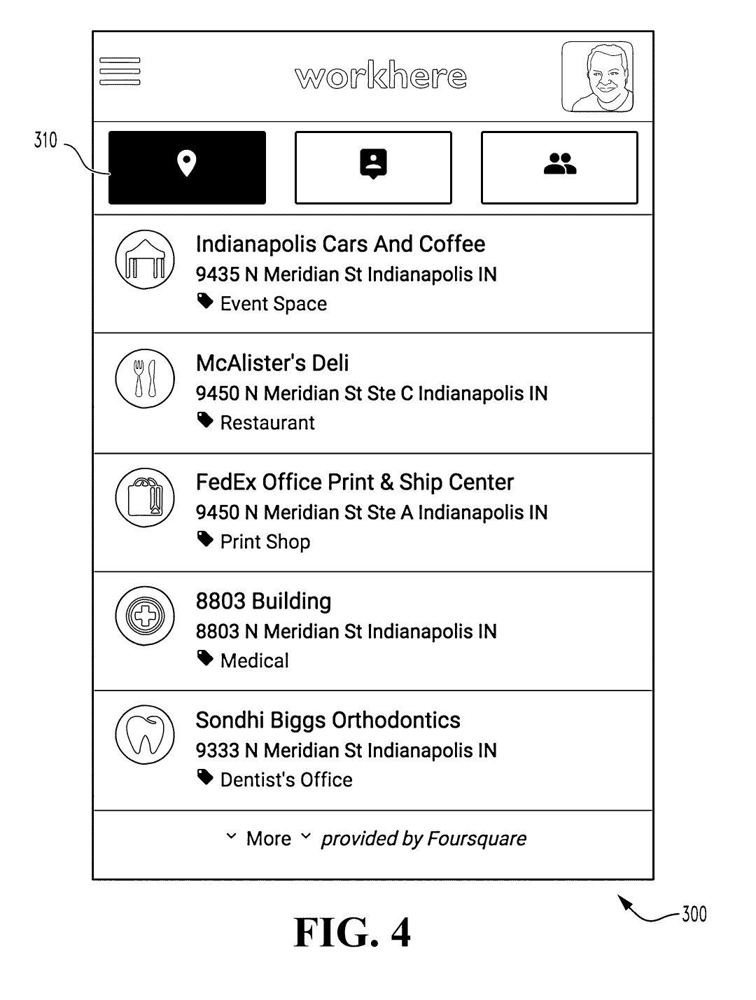

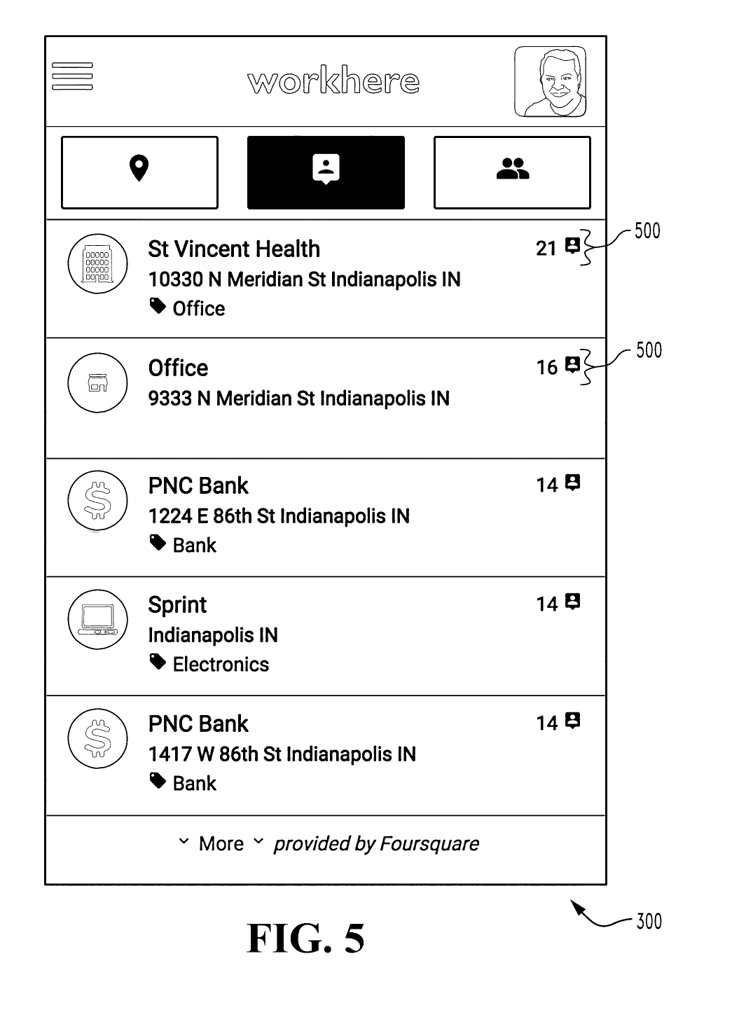

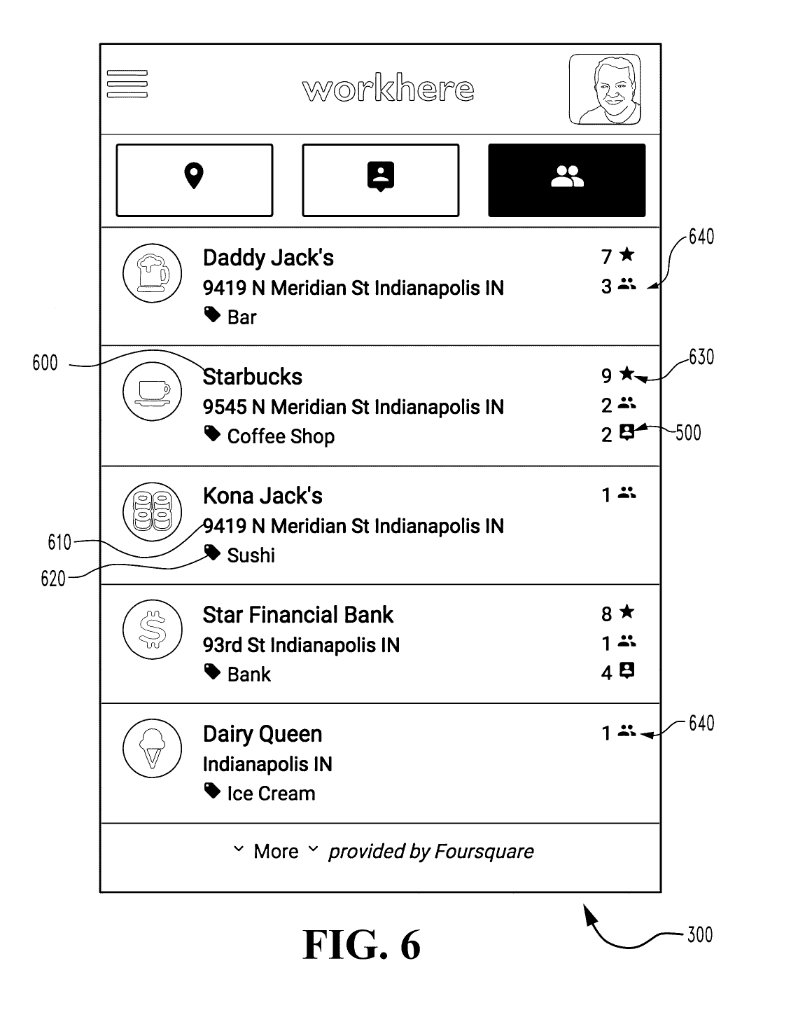

In some implementations, places view 300 may be filtered by various categories. These filters may be, but are not limited to, sorting by people, positions 900, and distance. A distance filter, as demonstrated in FIG. 4, typically may sort places 320 by distance from the current user (i.e., as determined by the user device 120 geolocation data). Alternatively, a positions filter, as depicted in FIG. 5, typically may sort places 320 by number of positions 500 at each place 320. Further, a people filter, as depicted in FIG. 6, typically may sort places 320 by number of place followers 640.

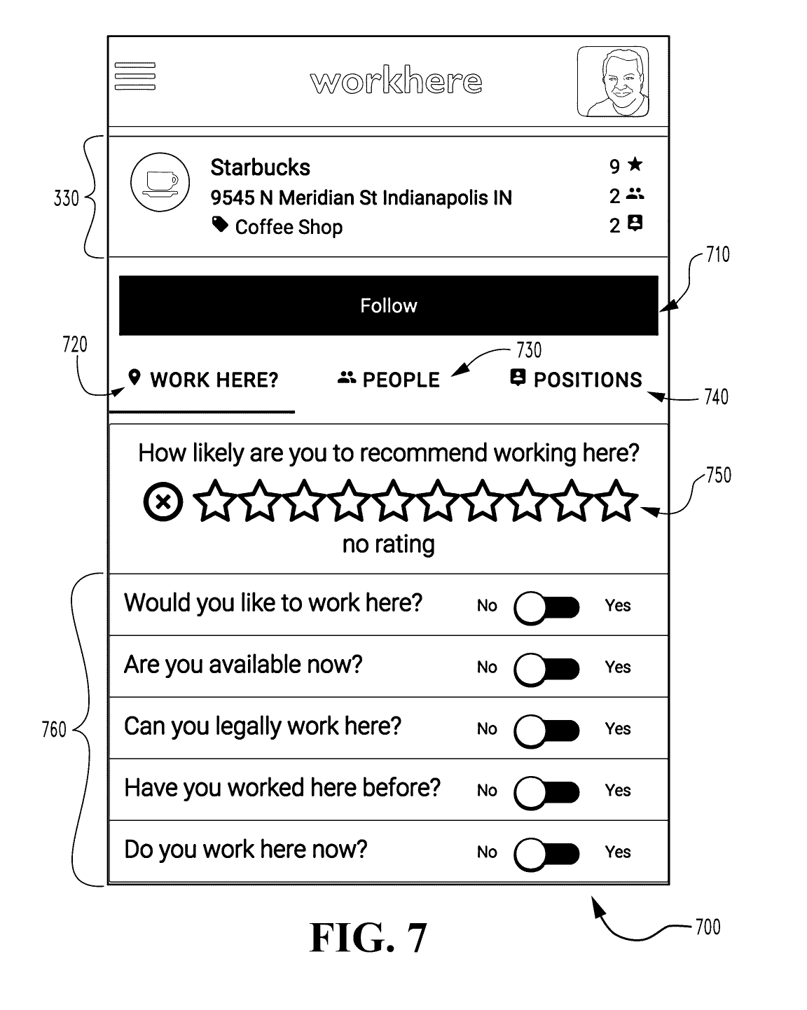

Places view 300 may be further granulized in place detail view 700, depicted in FIGS. 7-9, which typically consists of a place summary card 330, a follow button 710 and/or place owner control buttons 710, and tabs (e.g., system tab 720, people tab 730, and positions 740).

Viewing the place detail view 700 may typically cause the client to request the server to update the positions list 910 for the place 320. The server queries the system 105's jobs API with the specific place 320's name and/or location, and updates the positions collection for this place 320 with the search results returned to the user via client device 120. The server may then send the client one or more positions 900 that typically may not be already stored in the client side database. In some implementations, evergreen positions 900 added by the place owner typically may also be stored in the positions collection and sent to the client side database when the place detail page 700 typically may be viewed. In some other implementations, when a user visits a place detail view 700, the interaction typically may be recorded in a collection.

A place summary card 330 typically includes an icon that graphically represents the place type and typically may be color coded based on a number of states related to the place 320, such as the current user typically may be following place 320; place 320 has positions 900 and current user typically may not be following place 320; place 320 has no positions 900 and current user typically may not be following place 320; and/or the like.

For example, a place summary card 330 may contain (1) the place name 600 (e.g., Coffee Shoppe); (2) place address 610 (e.g., 1140 West Oak St, Jonesville, Ind.); (3) place type 620 (e.g., Coffee Shop); (4) place referral score 630; (5) place followers count 640; (6) place positions count 500; and/or the like.

Place detail view 700 may typically also include a follow button 710 that adds or removes the current user to the place followers collection when selected. In some implementations, where the current user typically may be the place owner for the place 320, then the follow button 710 typically may not be displayed, and instead place owner control buttons for editing the place 320 typically may be displayed.

Further, place detail view 700 may typically also depict a system tab 720, which typically may display a place rating control 750 and number of questions 760 (e.g., standard YES/NO, degree of agreement scales, and/or the like). For example, the place rating control 750 may use a scale of zero to ten stars to answer the question “How likely are you to recommend working here?” Further, five typical, but nonexclusive, YES/NO questions 760 that may be prompted may be (1) Would you like to work here? (i.e., an intent to work here segment); (2) Are you available now? (i.e., active/passive interest segment); (3) Can you legally work here? (legal requirements segment); (4) Have you worked here before (alumni segment); and (5) Do you work here now? (current employee segment). Other custom questions 760 may also be added by place owners.

The people tab 730 depicted in place detail view 700 typically displays a list of persons 800 and person summary cards 810 for each person 820 that typically may be following the place 320. Tapping a person summary card 810 typically may direct the GUI to the corresponding person detail view 1800.

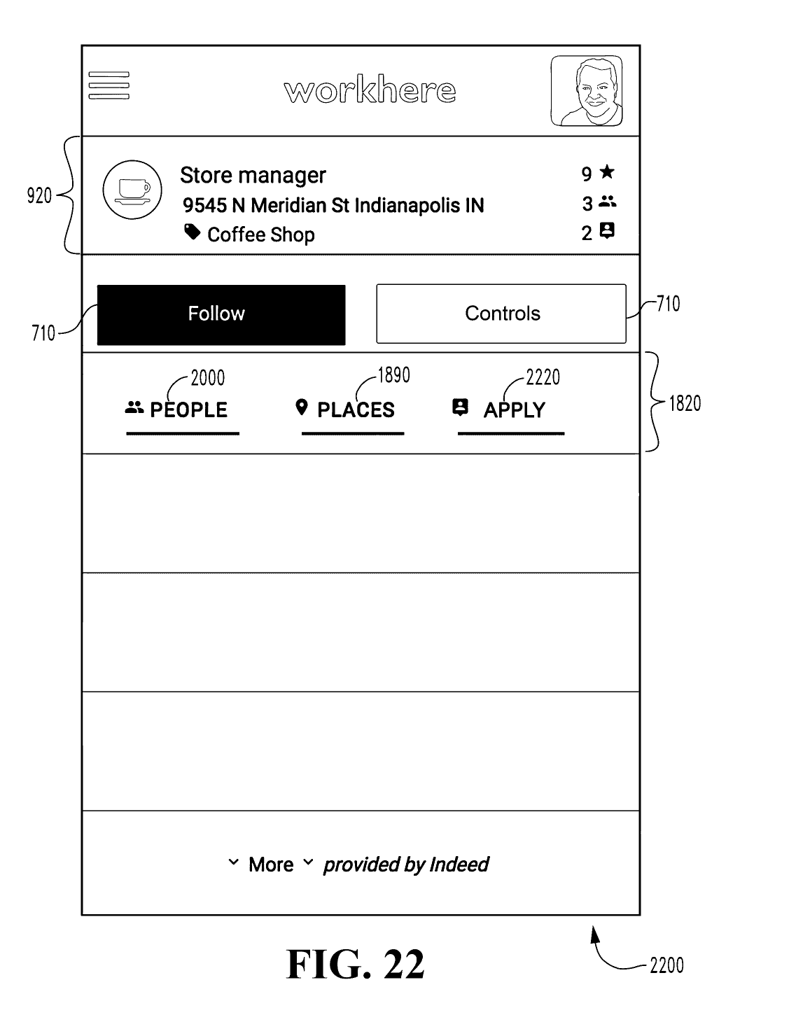

Similarly, positions tab 740 depicted in place detail view 700 typically displays a list of positions 910 and position summary cards 920 for each place position 900. Typically, tapping and/or otherwise indicating a position summary card 920 may direct the GUI to the corresponding position detail view 2200 (depicted in FIG. 22).

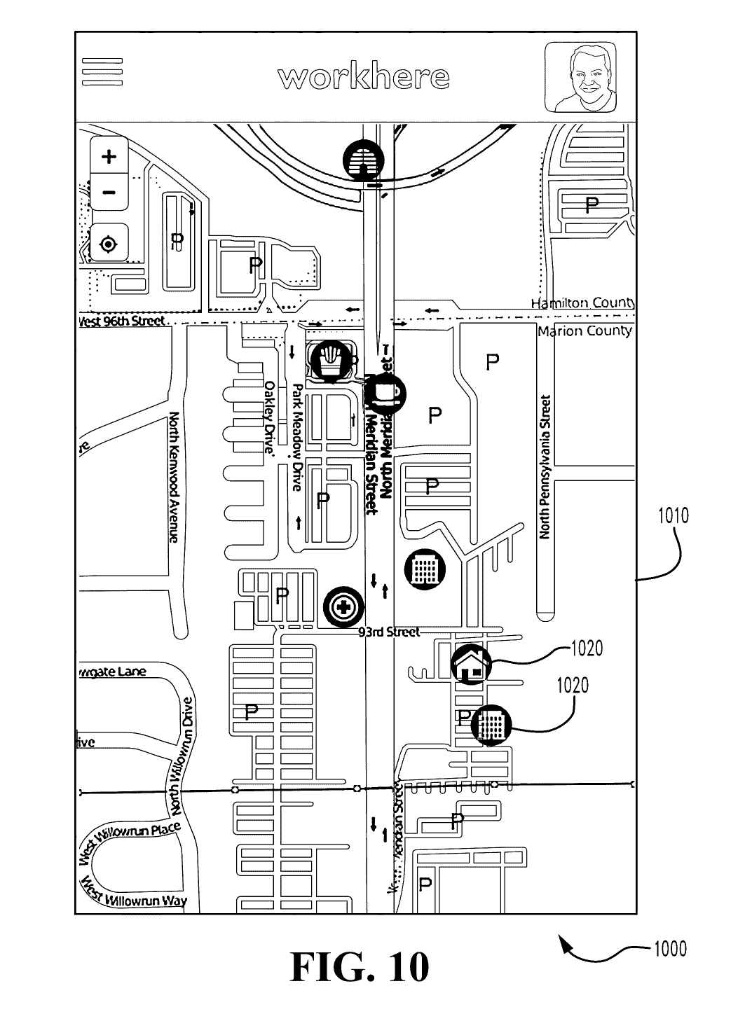

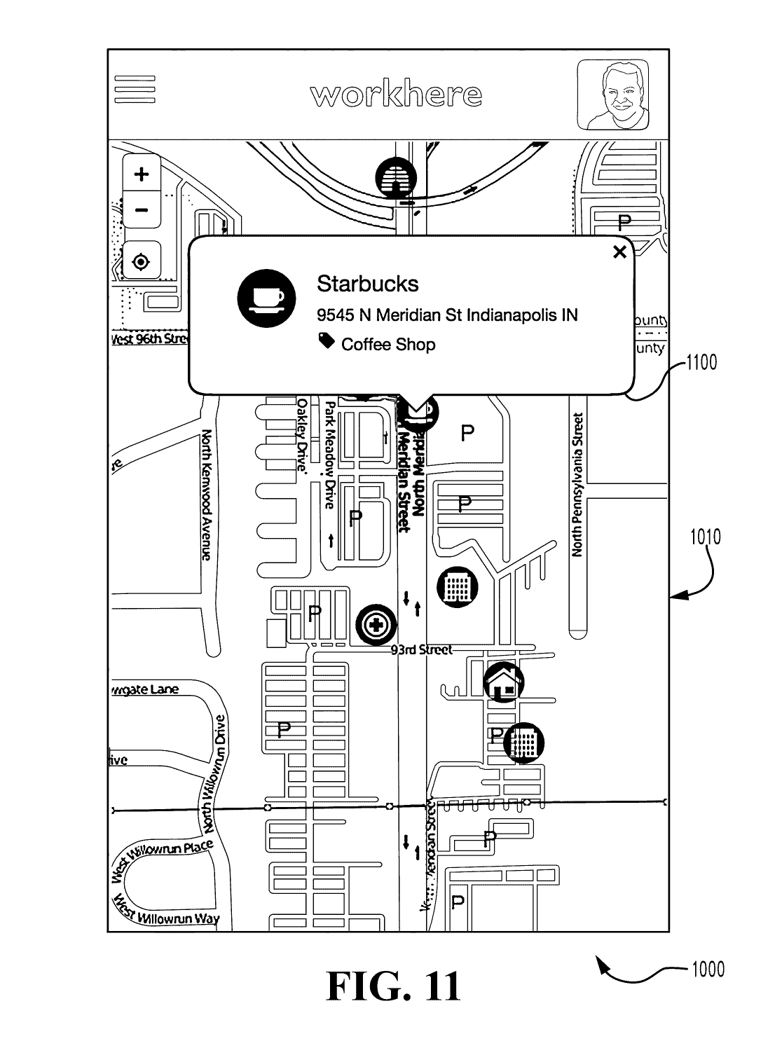

FIGS. 10-11 typically depict map view 1000 System 105's map view 1000 typically may be accessed by clicking the map icon 340 in the main navigation (e.g., places view 300) of the system 105 GUI. Within map view 1000, the location of the user typically may be used to display a map 1010 of the surrounding area. The bounding box of the map 1010 typically may be used to query the places API. Matching places 320 typically may be added to a map markers layer on the map 1010, and, in some implementations, map markers 1020 typically may use the same icons and color coding as place items.

Typically, tapping and/or otherwise selecting a map marker 1020 typically may open a popup 1100 on the map 1010 with a smaller version of the place summary card 330 that displays a subset of the associated place's data, such as the icon, name, address, and type of the place. In some further implementations, tapping on the popup 1100 typically may send the user to the place detail view 700 of the system 105 GUI, and tapping the map 1010 typically may close the popup 1100.

Further control of map view 1000, such as zooming and panning the map 1010 via click, touch, and tap events, typically may also be enabled. Zoom controls typically may change the zoom level of the map 1010, refresh control typically may force refresh of the places API bounding box query, and locate control typically may recenter the map 1010 by panning to the location of the current user.

For some implementations, small mobile devices may only display the map 1010. On larger screens, places view 300 typically may be included on a GUI sidebar, typically sorted by distance. Typically, tapping on a place summary card 330 in the sidebar sends the user to the place detail view 700 corresponding to the place summary card 330.

System 105's positions view 1200 typically may be accessed by clicking the person pin icon 1210 in the main navigation (e.g., places view 300) of the system 105 GUI. Positions view 1200 typically may be a list of position summary cards 910, and tapping or otherwise indicating on a position summary cards 920 typically navigates the user a corresponding position detail view 2200 (depicted in FIG. 22).

As above, positions view 1200 may also be filtered by place types and position types. For example, positions view 1200 may be sorted by, but not limited to, followers or distance filters. The followers filter may typically sort nearby positions by the number of position followers. Alternatively, the distance filter typically may sort nearby positions by distance from the current user.

Positions view 1200 may be further granulized into position detail view 2200, similar to place detail view 700, which typically may consist of a position summary card 920, follow button/place owner control buttons 710, and one or more tabs 1820 (e.g., People tab 2000, Places tab 1890, Apply tab 2220, and/or the like). In some implementations, when a user visits a position detail view 2200, the interaction typically may be recorded in a collection. Position detail view 2200 is depicted on FIG. 22.

A position summary card 920 typically may include, but is not limited to, (1) a person pin icon 1210 in a circle 1220 graphically representing a position; (2) the position title 1230; (3) the place name and place location for the position 1240; and (4) the number of people following the position 1250.

A follow button 710 on the position detail view 2200 may typically add and/or remove the current user to the position followers collection when clicked and/or otherwise selected. If the current user typically may be the place owner for the position, then the follow button 710 typically may not be displayed, and instead place owner control buttons 710 for editing the position typically may be displayed.

The people tab 2000 depicted on the position detail view 2200 may typically display a list of persons 800 and person summary cards 810 for each person 820 that is following the position. Tapping a person summary card 810 goes to the person detail view 1800.

The places tab 1890 depicted on the position detail view 2200 may typically display a list of place summary cards 330 for each place 320 that has the same position. Tapping a place summary card 330 goes to the place detail view 700.

The apply tab 2220 depicted on the position detail view 2200 may typically have three possible states: (1) if the position has an apply URL, then an apply button typically may be displayed with the apply URL as the click event action; (2) if the position has the invite option set, then a request invite button typically may be displayed; and (3) if the position has the in-person option set, then instructions for how to apply in person typically may be displayed.

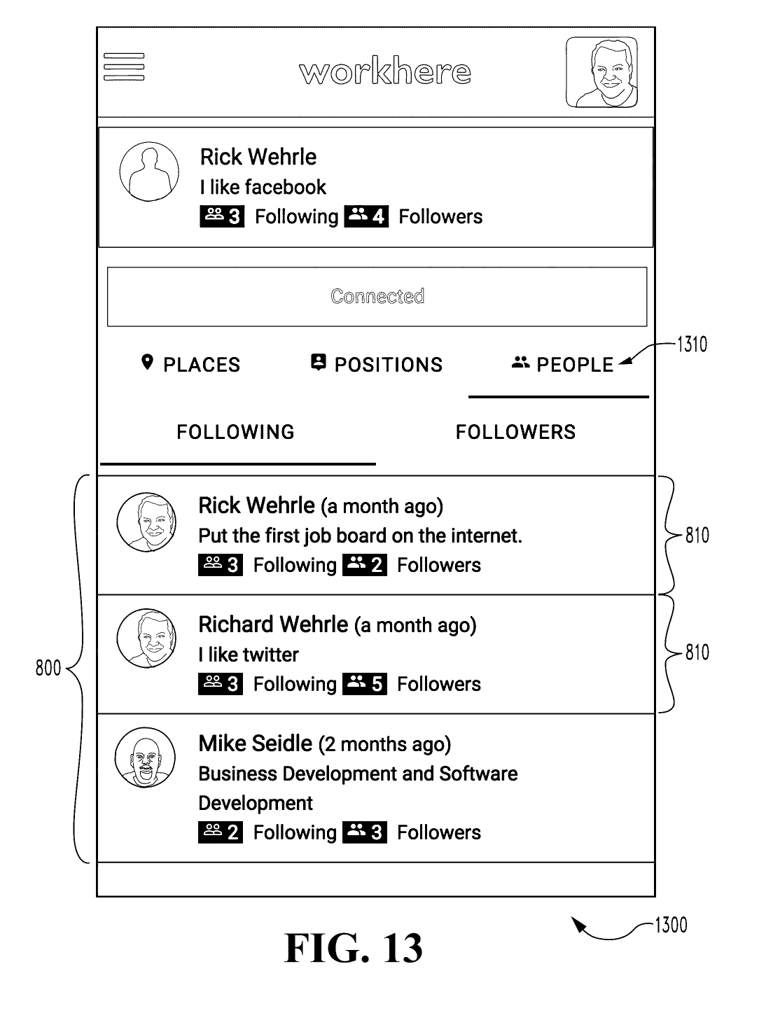

FIGS. 13-17 typically depict people view 1300. System 105's people view 1300 typically may be accessed by clicking the people icon 1310 in the main navigation (e.g., places view 300) of system 105 GUI. People view 1300 typically may be a list of persons 800 and person summary cards 810, wherein tapping and/or otherwise selecting a person summary card 810 directs the GUI to the person detail view 1800 associated with the corresponding person summary card 810.

Similarly, people view 1300 may be sorted by several filters, including but not limited to, followers, following, or distance. Followers filter, as depicted filtered in view 1500, typically may sort nearby people by each person's followers total. Alternatively, following filter, as depicted filtered in view 1600, typically may sort nearby people by each person's following total. Further, distance filter, typically depicted filtered in view 1700, typically may sort nearby people by distance from the current user.

People view 1300 may be further granulized into person detail view 1800, which typically may consist of a person summary card 810, a follow button or user control buttons 1810, and one or more tabs 1820 (e.g., for Places, Positions, and People).

A person summary card 810 typically may include, but is not limited to, (1) an avatar 1830 that graphically represents the person; (2) the person's name and headline 1840; (3) the number of people the person typically may be following 1850; (4) the number of people that typically may be following the person 1860; (5) the number of positions the person typically may be following 1870; (6) the number of places 320 the person typically may be following 1880; and/or the like.

A person follow button may be depicted on the person detail view 1800 may typically add or remove the person to the followers and followees collections for the current user when clicked. If person typically may be the current user, the follow button typically may not display, and instead user control buttons 1810 for editing the current user or logging out typically may be displayed.

The places tab 1890 depicted on the person detail view 1800 may typically display a list of place summary cards 330 for each place 320 the person typically may be following. Tapping and/or otherwise selecting a place summary card 330 typically may direct the system 105 GUI to the corresponding place detail view 700.

The positions tab 1900 depicted on the person detail view 1800 may typically display a list of positions 910 and position summary cards 920 for each position 900 the person typically may be following, as depicted in view 1910. Tapping and/or otherwise selecting a position summary card 920 typically may direct the system 105 GUI to the corresponding position detail view 2200.

The people tab 2000 depicted on the person detail view 1800, shown in view 2010, may typically have two more tabs: following and followers. Following tab 2020 typically may display a list of persons 800 and person summary cards 810 for each person 820 that the selected user typically may be following. Alternatively, followers tab 2030 typically may display a list of persons 800 and person summary cards 810 for each person 820 that typically may be following the selected use. Further, tapping and/or otherwise selecting a person summary card 810 typically may direct the system 105 GUI to the corresponding person detail view 1800. Additionally, when a user visits a person detail view 1800, the interaction typically may be recorded in a collection on system 105.

Chat view 2100 typically may be accessed by clicking the chat button 1895 on a person detail view 1800. The chat button 1895 typically may be displayed on a person detail view 1800 when a two-way follow relationship exists between the current user and the other person.

Chat view 2100 typically may include, but is not limited to, (1) a header displaying the summary card 810 of the recipient; (2) a list of messages 2110 between the sender and the recipient sorted by timestamp; and (3) a text area form 2120 for creating and sending new messages. Further, each message typically may include, but is not limited to (1) message sender's avatar; (2) message sender's name; (3) message timestamp; and (4) message text. In some additional implementations, the amount of the message and/or amount of message data granularity may be generated based on end user device 120's screen size, resolution, and/or like limitations.

System 105 chat functions typically may be implemented as over-the-top (OTT) messaging. For example, while sender typically may be typing a message, an online recipient also on chat view 2100 may see a partially formed message with status text 2130 indicating a remote message typically may be currently being typed. When the sender clicks the “Enter” button after typing a message, the message typically may be sent to a system 105 server and then the server sends the message to the recipient. In some implementations, if the recipient typically may be offline, a chat notification typically may be sent to them, with a link to connect to the chat, via the user's preferred offline message channel (e.g., email, push notifications, and/or the like).

System 105's profile view 1800 typically may be accessed by clicking the user avatar icon 350 in the main navigation (e.g., places view 300) of system 105 GUI. Profile view 1800 typically may be the person detail view 1800 for the current user.

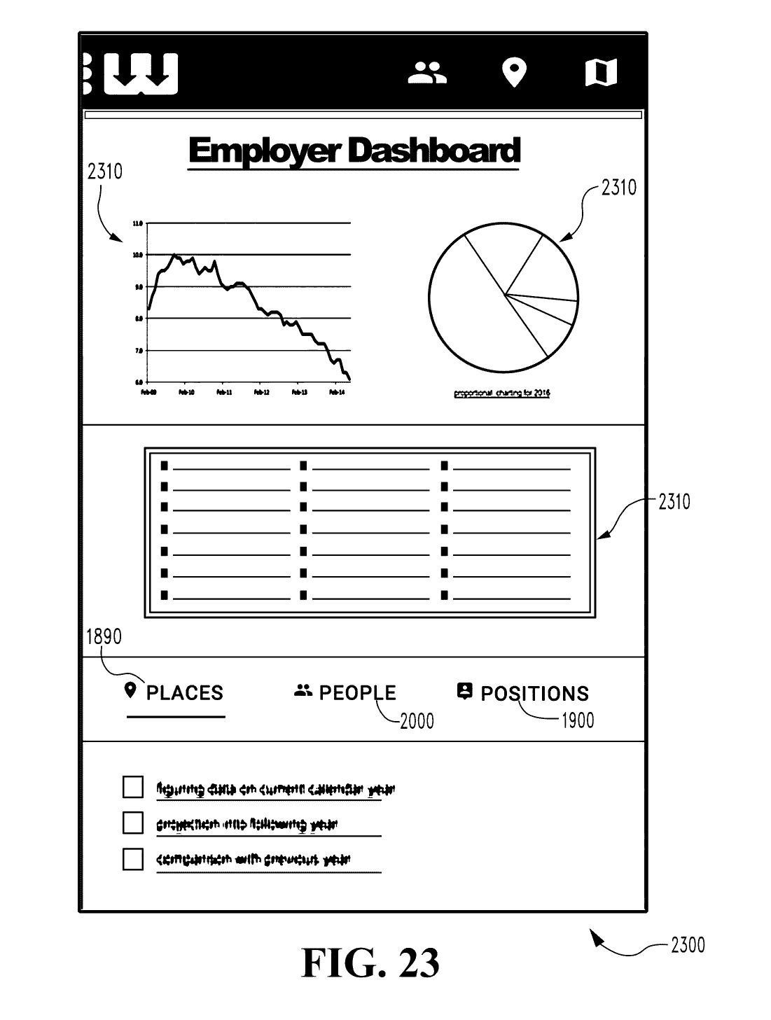

In some implementations of system 105, one or more employers-specific functionalities and/or views may be provided. For example, as depicted in FIG. 23, employer dashboard view 2300 may display employer metric visualizations 2310 (e.g., charts, graphs, etc.) of aggregated time series data for employer metrics, including but not limited to, number of place followers, position followers, message response rates, place ratings, and/or the like.

Such employer dashboard view 2300 may also include a number of tabs 1820 and/or actions as well. For example, the tabs 1820 may include, but are not limited to, (1) places tab 1890 (e.g., number of followers, employment net promoter score (eNPS), etc.); (2) people tab 2000 (e.g., stats on people segmented by position, place 320, and place answers, most recent followers/followees, etc.); and (3) positions tab 1900 (e.g., number of followers segmented by position 900 and place 320, most recent position 900 filled, most frequently turned over position 900, etc.). Actions may include, but are not limited to, adding and editing positions 900, adding and editing events, adding and editing messages, adding and editing people search segments, and/or the like.

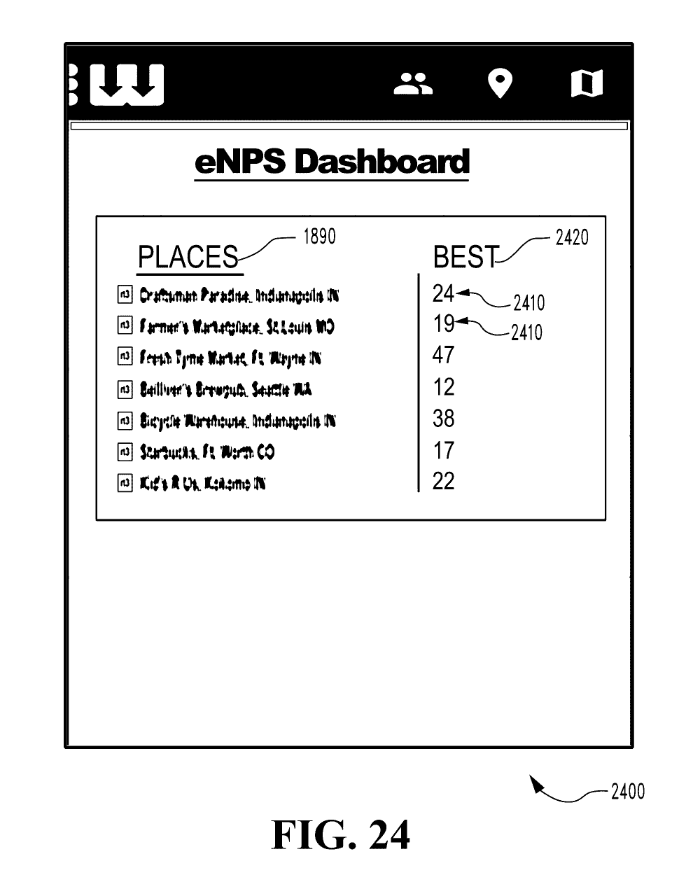

Another implementation, depicted on FIG. 24, may provide employment net promoter score (eNPS) 2410 in an eNPS view 2400 typically may be a method of rating employer brand performance and employee engagement. eNPS view 2400 may include tabs 1820 such as, but not limited to, places tab 1890 (e.g., shows places 320 user has access to and their eNPS score 2410) and/or best tab 2420 (e.g., shows top ten best performing places 320 (or top thirty-three percent if under thirty places 320). eNPS view 2400 may also allow actions such as, but not limited to, sharing one or more eNPS 2410 reports showing all locations to recipients.

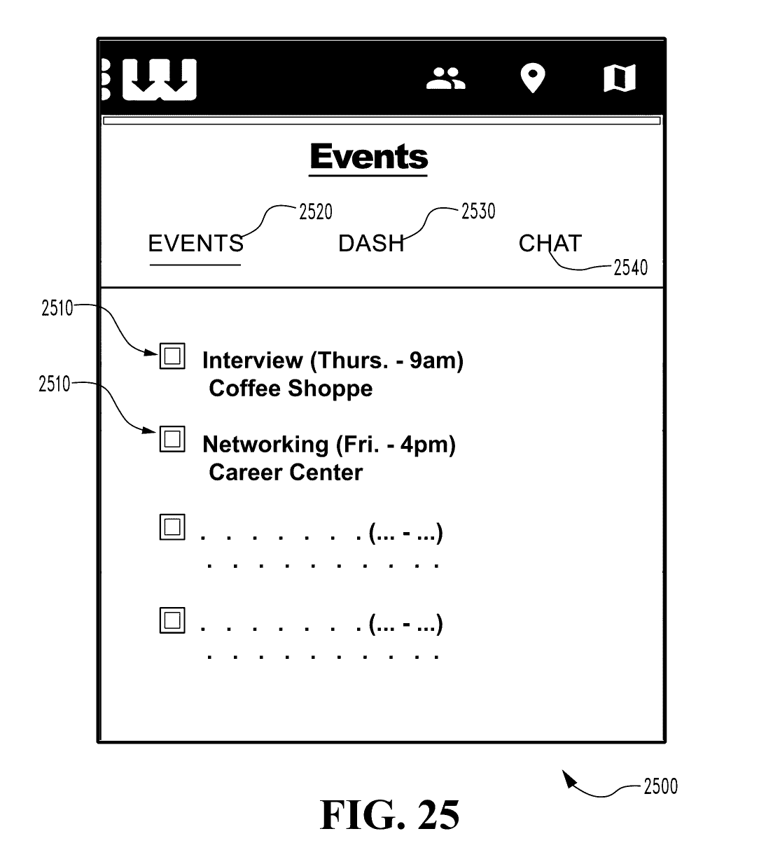

Still another implementation may provide events view 2500, depicted on FIG. 25, which may show some and/or all hiring events and interviews 2510 that have been scheduled. Typically, events view may have a number of tabs 1820 that further detail information stored in system 105. For example, events tab 2520 may show a list of events 2510, which when tapped or otherwise selected, may direct a user to a detailed view (e.g., event detail view 2600, described below). A dashboard tab 2530 may typically show marketing performance of the event 2510 including statistics including, but not limited to, number of individuals invited, number of individuals who attended, list of messages sent to promote event, and/or the like. Further, a chat tab 2540 may typically allow users who are invited to an event 2510 and/or that attended an even to discuss the event 2510 before, during, and/or after the event's occurrence. Events view 2500 may also, in some implementations, allow a user to create a new event 2510 and define one or more event 2510 specifics.

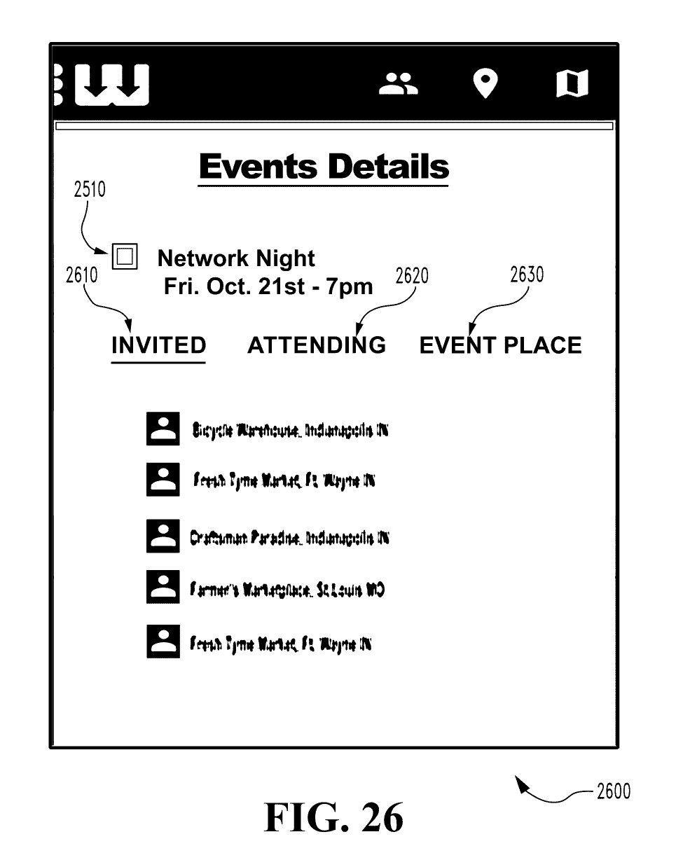

In some implementations, events view 2500 may be further granulized as event detail view 2600, depicted on FIG. 26, and may show some and/or all events/scheduled interviews 2510, date and time scheduled, number of people attending, and/or the like. Event detail view 2600 may include one or more tabs 1820, including but not limited to, invited tab 2610 (shows all people invited to event); attending tab 2620 (shows all people attending the event); and/or event place tab 2630 (shows where the event typically may be being held). Events view 2500 may also allow actions including, but not limited to, message attendees (sends a chat email, push message, SMS, system message to people attending or who have attended, and/or the like); invite (allows user to message all or selected people following their place 320 by email, invitations from other services, and/or the like); promote (allows user to send messages to talent communities to promote event); and/or delete (removes event).

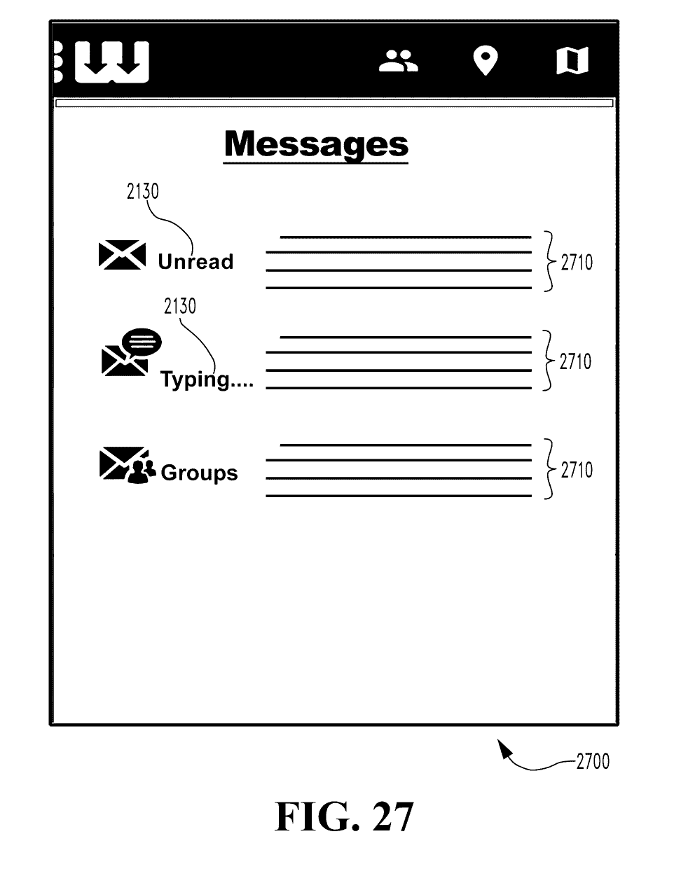

In some implementations, further views may also be provided, including but not limited to, messages view 2700, places view 300, people view 1300, positions view 1200, and/or the like. In messages view 2700, depicted in FIG. 27, messages 2710 typically may include the following forms of communication: email, push messages (e.g., notifications, etc.), over-the-top messages (e.g., chat, etc.), in-app messages, and/or the like. Places view 300 typically may show some and/or all places 320 owned or managed by a user and allow a manager and/or place owner to filter users by multiple criteria. Place owners and managers may select places 320 and send messages to followers, employees of, and people who want to work at those places 320. People view 1300 typically may show some and/or all people following a place 320 or group of places 320 accessible to the user. Place owners and managers may filter and select people and send messages, invite, and/or ask people to invite users to system 105. Additionally, positions view 1200 typically may show some and/or all positions 900 listed by a place 320 or group of places 320 accessible to the user. Place owners and managers may filter and select people and send messages, invite and ask people to invite users to system 105.

In some implementations, system 105 may typically utilize and/or enable one or more data collection measures to provide and/or enhance system 105 functions and/or user integration. A data collection measure typically may be one recorded document or metadata subdocument, which may be internal and/or external to system 105.

Measures typically may be one or more named actions with one or more associated properties. Measures typically may track user interactions with system 105 and may be recorded in one or more storage engines; including log files, database collections, and/or search engine indexes. For example, when a new account is created, the “Account Created’ event may be recorded with properties describing the new user account, including a timestamp and their current location (longitude, latitude, IP, etc.). Collections of measures typically may be measure logs.

In some implementations, a subset of public measures may be displayed on one or more user's activity feed page, where other users may interact with the public measured. In some further implementations, Public events may be used to enable alerts, recommendations, and/or trigger automated actions as well as trigger marketing campaigns.

One such measure may be user geometry, which typically may be the current longitude and latitude of the user while using the application typically may be collected and stored as a subdocument with each recorded document measure below. For example, the place detail view measure may include a subdocument of the user geometry when the view occurred.

Another measure may be place geometry, which typically may be the longitude and latitude of the place 320 typically may be stored as a subdocument with each recorded document measure below. For example, the place follow measure may include a subdocument of the place geometry when the follow occurred.

Yet another measure may be the places map impression measure, wherein each place 320 matching a map boundary box geospatial query for the map view 1000 typically may be recorded as a places map impression document with subdocuments for user geometry and place geometry. This typically may be used for filtering nearby people with high affinity for invites and messaging.

In a places list impression measure, each place 320 matching a nearby places 320 geospatial query for places view 300 typically may be recorded as a places list impression document with subdocuments for user geometry and place geometry. Further, in some implementations, when the user visits a place detail view 700 page, a place detail view document typically may be recorded with subdocuments for user geometry and place geometry.

In still another measure, when the user follows a place 320, a place follow document typically may be recorded with subdocuments for user geometry and place geometry. Similarly, when the user unfollows a place 320, a place unfollow document typically may be recorded with subdocuments for user geometry and place geometry. And, further when the user answers a place question (e.g., by clicking YES or NO on a place question), a place answer document typically may be recorded with user geometry and place geometry.

Additionally, regarding position features in system 105, when the user visits a position detail view 2200, a position detail view database document typically may be recorded with subdocuments for user geometry and place geometry. As above, when the user follows a position 900, a position follow document typically may be recorded with subdocuments for user geometry and place geometry. When the user unfollows a position 900, a position unfollow document typically may be recorded with subdocuments for user geometry and place geometry. Further, when the user clicks the apply button, a position apply click document typically may be recorded with user geometry and place geometry.

Regarding the people functionalities of system 105, each person 820 matching a nearby people geospatial query for the people view 1300 typically may be recorded as a people list impression document with subdocuments for current user geometry and the matching person user geometry. Additionally, when the user visits a person detail view 1800 page, a person detail view database document typically may be recorded with subdocuments for current User Geometry and the viewed person user geometry.

Further, also as above, when the user follows a person, a person follow document typically may be recorded with subdocuments for the current user geometry and followed person user geometry. Similarly, when the user unfollows a person, a person unfollow document typically may be recorded with subdocuments for the current user geometry and unfollowed person user geometry.

Regarding the messaging functionality of system 105, typically when a message 2710 is sent, a message document with sender and recipient user subdocuments, and a subdocument for the sender user geometry typically may be recorded. Also, when the recipient views a message, a message view document typically may be recorded with a subdocument for the recipient user geometry. Further, when the recipient clicks a message 2710 link, or otherwise takes action with the message 2710, a message action document typically may be recorded with a subdocument of the recipient user geometry.

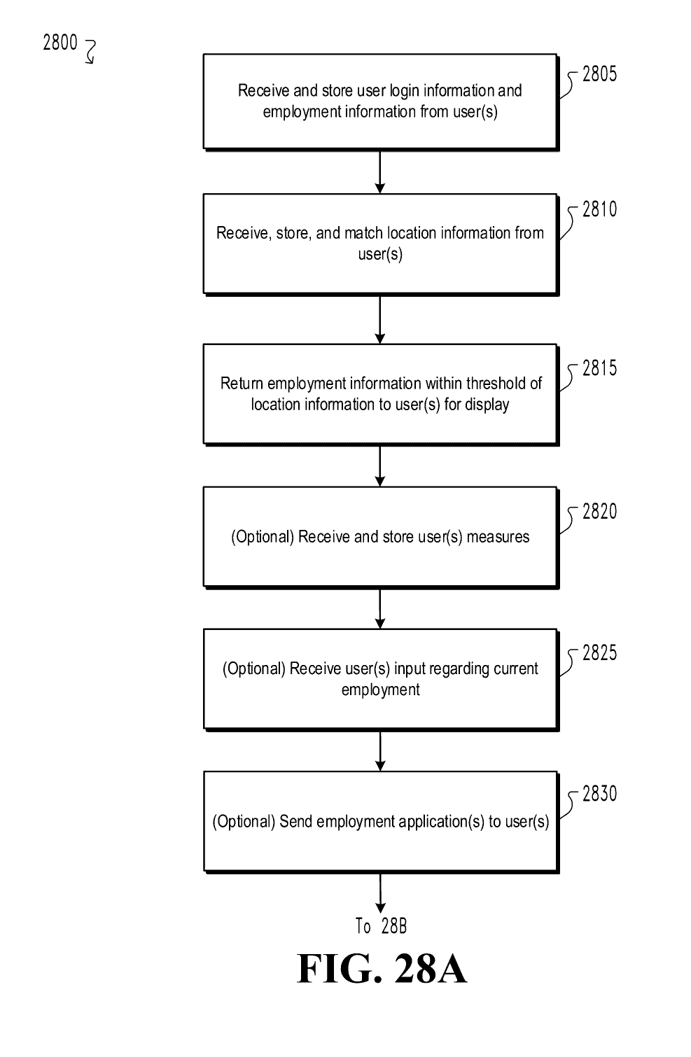

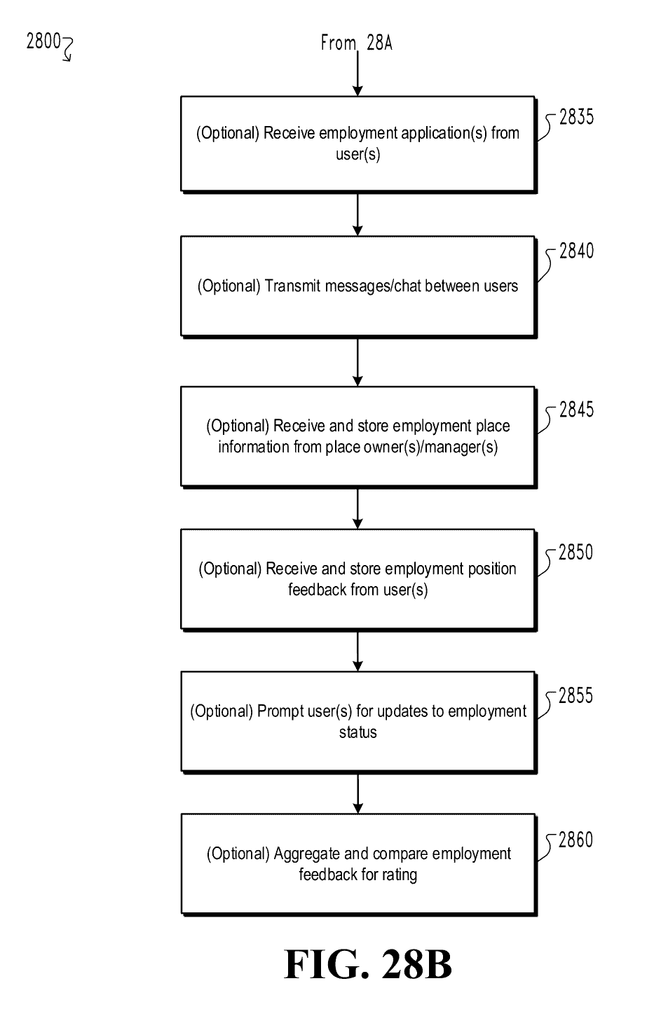

FIGS. 28A-28B depict a high-level process flow describing operation of system 105, typically including system process flow 2800; receive and store user login information and employment information from user(s) 2805; receive, store, and match location information from user(s) 2810; return employment information within threshold of location information to user(s) for display 2815; (optional) receive and store user(s) measures 2820; (optional) Receive user(s) input regarding current employment 2825; (optional) Send employment application(s) to user(s) 2830; (optional) Receive employment application(s) from user(s) 2835; (optional) Transmit messages/chat between users 2840; (optional) Receive and store employment place information from place owner(s)/manager(s) 2845; (optional) Receive and store employment feedback from user(s) 2850; (optional) Prompt user(s) for updates to employment status 2855; and/or (optional) Aggregate and compare employment feedback for rating 2860 steps.

During receive and store user login information and employment information from user(s) 2805, system 105 typically may receive and/or store information from user for credentials. This may, for example, be social media account credentials, local account credentials on system 105, biometrics, and/or any other user login information. System 105 typically may also receive employment information including places of employment, employment positions, and/or the like. In some implementations, this information may be indexed and/or scraped from other sources (e.g., local job posting websites, via an API to third-parties, and/or the like.)

During receive, store, and match location information from user(s) 2810, system 105 typically may receive location information (e.g., triangulated coordinates, GPS coordinates, WiFi locations, etc.), which may then typically be used during return employment information within threshold of location information to user(s) for display 2815 to track, compare, and/or offer employment information (e.g., new job postings, new employment places opening, change in reviews, job application response, and/or the like).

Further, during optional receive and store user(s) measures 2820, measures and/or metrics may be received and stored by system 105. For example, a user's following an employment place or position, visiting a networking event, messaging a user, requesting/submitting a job application, and/or the like may be recorded measures. Additionally, during optional receive user(s) input regarding current employment 2825, system 105 typically may receive input regarding current employment of user. For example, system 105 may send/generate prompts with employment questions (described elsewhere in this application), ask for traditional field input, and/or the like.

Also, during optional send employment application(s) to user(s) 2830, system 105 may send one or more employment applications to one or more users. For example, system 105 may match a user's historical measures with currently available positions in a geographic threshold, recommend similar positions not explicitly selected, and/or the like. In some implementations, system 105 may help user(s) complete applications may prepopulating application fields with information stored on system 105 (e.g., name, email, phone, previous employers, letters of recommendation, current address, social security number, credit report score, and/or the like). Further, during optional receive employment application(s) from user(s) 2835, system 105 may be a repository and/or transmission hub for employment applications between employers and/or employees on system 105. For example, a user may send back a completed application to system 105 from step 2835, receive scanned third-party applications, and/or the like.

Additionally, during optional transmit messages/chat between users 2840, system 105 may act as a message and/or chat hub for users of system 105. For example, employers and/or employees may message each other, payroll information may be exchanged, users may inform others (users and/or nonusers) of employment opportunities, and/or the like. During optional receive and store employment place information from place owner(s)/manager(s) 2845, one or more authorized individuals (typically the user identified (self and/or elected) as place owner, or set as a manager based on employment status (and typically one or more secondary authentications, such as owner verification, email address, business card, name tag, and/or the like) may submit updates and/or information about place, management, positions, and/or the like. For example, a manager could post a new front desk position, update hours, review job applications, and/or the like.

Additionally, during optional receive and store employment feedback from user(s) 2850, system 105 may receive and store feedback from users regarding their position, management, place, and/or the like. For example, a current and/or former employee (i.e., a user having previously given measure and/or information on system 105 as being employed at employment place) may answer a questionnaire and/or submit rankings (e.g., stars, grading scales, etc.) regarding his or her personal experience at the employment place. Users may, for example, also submit text reviews, suggestions, comments, criticism, and/or the like for other system 105 users to see. In some implementations, such submissions may be vetted and/or blocked by system 105 moderators and/or employers based on posting factors (e.g., sensitive information, profanity, refuted lies, and/or the like).

Additionally, optional prompt user(s) for updates to employment status 2855 may act to maintain periodic checks of employment status, position, and/or the like. For example, upon every so many user logins, system 105 may prompt user to verify that he or she is still employed in his or her indicated position. System 105, in other implementations, may also send messages (email, SMS, MMS, direct message, etc.) to prompt users who infrequently log into system 105, and/or system 105 may eventually deactivate dormant accounts of users who refuse to update their status.

Further, during optional aggregate and compare employment feedback for rating 2860, system 105 may receive, store, aggregate, and analyze feedback from system 105 users regarding employment places and/or positions to generate scores. These scores may, for example, be specialized (e.g., eNPS), relative to a user, generalized over the entire user base and/or geographic user base, and/or the like. As described elsewhere in this application, scores may be derived from personal experiences, comparative ranking, machine learning, and/or the like. Thus, system 105 may analyze and weigh poorly reviewed positions and/or places, suggesting and/or ranking these poor performers lower on system 105 lists for users. In some implementations, certain places and/or positions may be flagged for removal and/or review based on feedback that falls outside a significant threshold (e.g., always receiving maximum feedback, always receiving lowest feedback, falling below an acceptable threshold of management, and/or the like). Such environmental and/or quality checks typically may allow system 105 to monitor potential abuse of system 105 and/or employees.

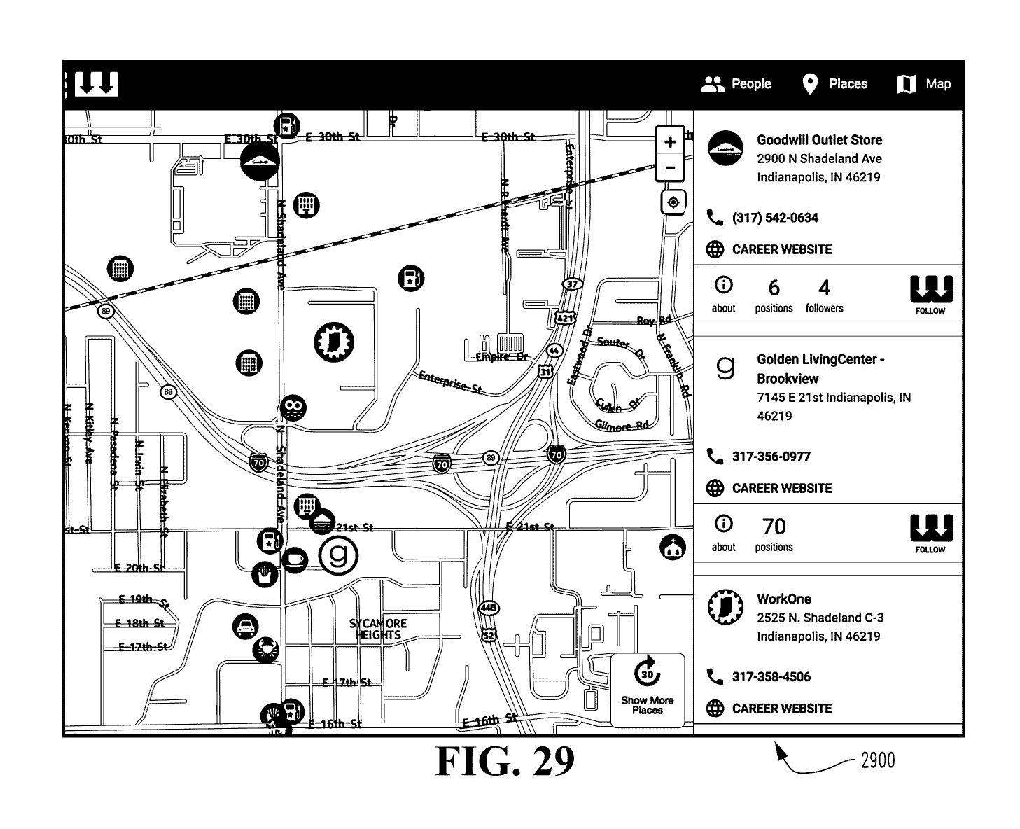

FIGS. 29-34 depict screenshots of further implementations of the system's user interface views on various user devices, including map view 2900, people view 3000, places view 3100, positions view 3200, profile places view 3300, and user profile view 3400. These views, and their component features, may of course be used in conjunction with, and/or separate from, other views and/or components described elsewhere in this application and are in no way intended to be limiting to any specific embodiments, but provided merely for further examples for use with system 105.

With the system 105 components and features described above, now various exemplary use cases will be described. These use cases are for the purpose of nonlimiting examples only, and do not in any way limit other use cases, combinations, modifications, and/or the like. These use cases may, alternatively, be presented as linear and/or nonlinear process flows, similar to above-described FIG. 28.

One usage may be for one or more methods for tracking application starts and/or completes via a browser plugin/extension and/or reporting employment searches to workforce agencies (e.g., government, etc.). For example, this usage may function accordingly:
a. Browser plugin/extension is installed in web browser;
b. System 105/plugin monitors user activity and looks for URLs, content, and/or HTML structure consistent with job boards, corporate career websites, and/or applicant tracking systems;
c. Actions logged by the system 105/plugin may be, but are not limited to, website visits; search queries (location, industry, occupation, category, keywords); job views; apply clicks; application starts; application completes;
d. Logged actions may trigger follow up tasks for the user may be, but are not limited to, follow job; follow place; schedule event reminder to follow up;
e. Logged actions are used to identify may be, but are not limited to, change from passive job search to active job search; user interest in job categories and titles; user interest in employers; user interest in geographic area;
f. PDF reports may be generated for the user to provide to his/her caseworker at the state workforce agency, either via email, or printed and delivered in person; and
g. If a user connects his/her workforce account with the plugin, then logged actions and reports typically may be provided directly to the case management system.

Another usage may be for one or more methods for identifying when users have changed jobs through the use of place answers and device location data to determine when user is employed, unemployed, and/or has changed jobs. For example, this usage may function accordingly:
a. Analyze recency, frequency, and/or latency of user geometry data and/or code the locations as work, home, and/or play areas;
b. When a new work location is coded, prompt the user to update his/her “Do you currently work here?” answer for the location;
c. When an existing work location becomes dormant, prompt the user to update his/her “Do you currently work here?” answer for the location;
d. When a user changes the “Do you currently work here?” answer for any location, prompt the user to review all locations that they currently have marked with a Yes answer; and/or
e. Users may have one or more jobs. So, coding may also attempt to identify regular shift times for each location, such as days/nights or weekdays/weekends.

A further usage may be for one or more methods for identifying when someone leaves a job for unemployment integrity reporting. For example, this usage may function accordingly:
a. Use place answers and/or device location data to determine when user is employed, unemployed, and/or has changed jobs;
b. Analyze recency, frequency, and/or latency of user geometry data and code the locations as work, home, and/or play areas;
c. When a new work location is coded, prompt the user to update his/her “Do you currently work here?” answer for the location;
d. When an existing work location becomes dormant, prompt the user to update his/her “Do you currently work here?” answer for the location;
e. When a user changes the “Do you currently work here?” answer for any location, prompt the user to review all locations that he/she currently have marked with a Yes answer;
f. Where users may have one or more jobs, attempt to identify regular shift times for each location, such as days/nights and/or weekdays/weekends;
g. Message employer using one or more push messages, emails, SMSs, and/or other method to alert that the user no longer works at the location; and/or
h. Report to the local governmental workforce agency via detailed dashboard with analytical data derived from the unique activities.

Yet another usage may be for one or more methods for ranking prospective employees. For example, this usage may function accordingly:
a. Using one or more machine learning techniques (e.g., side-by-side A/B machine learning, etc.):
   i. Two or more people may be randomly selected from list of friends; and
   ii. User clicks on person with whom he/she would rather work (e.g., A or B); and
b. Repeat until one or more subsets of all friends, or all friends, have been compared or user stops ranking.

Another usage may be for one or more methods for ranking prospective employers. For example, this usage may function accordingly:
a. Using one or more machine learning techniques (e.g., side-by-side A/B machine learning, etc.):
   i. Two or more employers may be randomly selected from list of nearby places; and
   ii. User clicks on employer with whom he/she would rather work (e.g., A or B);
b. Repeat until one or more subsets of all places, or all places, have been compared or user stops ranking;
c. Assign user rankings to each place, along with number of nearby places ranked by user in session, and, optionally, coordinates of user when ranking; and/or
d. Assign place ranking based on average of user rankings, weighted by relative number of places ranked by user in area.

Still another usage may be for one or more methods for creating hyper-local talent pipelines using geographically constrained check-ins signaling employment intent. For example, this usage may function accordingly:
a. Person is physically near Place;
b. Person opens system 105 App on his/her device;
c. App requests Person to share location;
d. Person clicks OK, and then device shares coordinates (e.g., GeoJSON Point) with App;
e. App calls system 105 server to send geospatial query to Places API;
f. Places API returns list of nearby Places with coordinates, which typically may be stored and/or cached in the Places collection on the system 105 server;
g. App subscribes to a geospatial query published from system 105 server Places collection using the coordinates from the device;
h. List of nearby Places typically may be returned and/or displayed in App;
i. Typically, for each place in list, a Place Impression measure may be recorded with User and/or Place Geometry;
j. Person selects and/or views a Place profile in App;
k. Place View measure is recorded with User and/or Place Geometry;
l. Person follows Place in App;
m. Place Follow measure is recorded with User and/or Place Geometry;
n. Follow action calls Place Follow system 105 server method;
o. Place Follow system 105 server method calls Log Person Here server method, which typically may log Person User ID and/or Place coordinates in People Here collection (People Here typically may be a collection of hyper local talent pipelines); and/or
p. If person does not convert to Place Follower, then Place Impression and Place View measures may be used to generate lists of potential people to message with event and/or follow invites.

Yet another usage may be for one or more methods for advertising employment opportunities and capturing employment intent via geographically constrained check-ins. For example, this usage may function accordingly:
a. Include Jobs API call and/or evergreen Positions within above method for creating hyper local talent pipelines using geographically constrained check-ins signaling employment intent.

A further usage may be for one or more methods for using geographic data from user social activity to augment local talent pipeline recommendations. For example, this usage may function accordingly:
a. User logs into App with Social Account and/or otherwise connects Social Account with User account for App;
b. App monitors social activity for geographically tagged posts and typically may record the coordinates of the social posts into a Coordinates GeometryCollection document associated with one or more User IDs in the Active Here collection; and/or
c. Provide Active Here filter of the People Here collection using this social activity.

Another usage may be for one or more methods for using geosocial data for job recommendation. For example, this usage may function accordingly:
a. Social post (tweet, facebook post, etc.) containing job search related text occurs;
b. Geodata from post is used to search one or more Place databases;
c. Place data is used to query job listings;
d. Places and jobs are compiled into message; and/or
e. Message typically may be sent via one or more communication modes (e.g. direct message, email, SMS, MMS, push message, display ad, and/or the like.)

A further usage may be for one or more methods for alerting job seekers of open positions nearby. For example, this usage may function accordingly:
a. Geofence typically may be created by analyzing the Active Here and People Here collections;
b. Geofence typically may be registered with provider notification service; and/or
c. When the job seeker is inside the geofence, or within a threshold value, and near a place in system 105 database that has an open job listed in the app (e.g., from Jobs API, listed in a database of evergreen positions, etc.), a push message typically may be sent to the job seeker.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system 105 components in the embodiments described above should not be understood as requiring such separation in all embodiments, and it should be understood that the described program components and systems may typically be integrated together in a single hardware and/or software product or packaged into multiple hardware and/or software products.

Thus, particular embodiments of the subject matter have been described. Other embodiments are within the scope of the following claims. In some cases, the actions recited in the claims may be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method for establishing an employment tracking system over a computer network, comprising the steps of:
receiving and storing user login information from at least one user;
receiving and storing employment information, wherein employment information includes at least one employment place and at least one employment position, and wherein the at least one employment place and the at least one employment position have corresponding geographic coordinates;
receiving and storing user geographic location information from the at least one user;
matching the stored user geographic location information with the corresponding geographic coordinates of the at least one employment place and the at least one employment position; and
returning employment information within at least one user-defined threshold to the at least one user for display.

2. The method of claim 1, further comprising the step of:
receiving and storing measures from the at least one user.

3. The method of claim 1, further comprising the step of:
receiving input from the at least one user regarding a current employment position held by the at least one user.

4. The method of claim 1, further comprising the step of:
sending at least employment application to the at least one user; and
receiving the at least one employment application from the at least one user.

5. The method of claim 1, further comprising the steps of:
receiving at least one desired employment place and at least one desired employment position from the at least one user; and
sending at least one message to the at least one user when the at least one desired employment place and the at least one desired employment position is open for application.

6. The method of claim 1, further comprising the step of:
receiving input from the at least one user regarding a current employment position held by the at least one user.

7. The method of claim 1, further comprising the step of:
receiving and storing at least one feedback from the at least one user about the at least one employment place and the at least one employment position.

8. The method of claim 7, further comprising the step of:
aggregating and analyzing the at least one feedback from the at least one user about the at least one employment place and the at least one employment position; and
deriving at least one score for the at least one employment place and the at least one employment position based on the aggregated and analyzed at least one feedback from the at least one user.

9. A system for providing a social employment system platform over a computer network configured to overate over a network using at least one server and at least one user, comprising:
a server operating the social employment system platform, the server adapted to communicate with the network;
wherein the server is configured to:
receive and store user login information from at least one user;
receive and store employment information, wherein employment information includes at least one employment place and at least one employment position, and wherein the at least one employment place and the at least one employment position have corresponding geographic coordinates;
receive and store user geographic location information from the at least one user;
match the stored user geographic location information with the corresponding geographic coordinates of the at least one employment place and the at least one employment position; and
return employment information within at least one user-defined threshold to the at least one user for display.

10. The system of claim 9, wherein the server is further configured to:
receive and store measures from the at least one user.

11. The system of claim 9, wherein the server is further configured to:
receive input from the at least one user regarding a current employment position held by the at least one user.

12. The system of claim 9, wherein the server is further configured to:
send at least employment application to the at least one user; and
receive the at least one employment application from the at least one user.

13. The system of claim 9, wherein the server is further configured to:
receive at least one desired employment place and at least one desired employment position from the at least one user; and
send at least one message to the at least one user when the at least one desired employment place and the at least one desired employment position is open for application.

14. The system of claim 9, wherein the server is further configured to:
receive input from the at least one user regarding a current employment position held by the at least one user.

15. The system of claim 9, wherein the server is further configured to:
receive and store at least one feedback from the at least one user about the at least one employment place and the at least one employment position.

16. The system of claim 15, wherein the server is further configured to:
aggregate and analyze the at least one feedback from the at least one user about the at least one employment place and the at least one employment position; and
derive at least one score for the at least one employment place and the at least one employment position based on the aggregated and analyzed at least one feedback from the at least one user.

17. A system for providing an employment tracking system over a computer network configured to overate over a network using at least one server and at least one user, comprising:
a server operating the employment tracking system, the server adapted to communicate with the network;
wherein the server is configured to:
receive and store user login information from at least one user;
receive and store employment information, wherein employment information includes at least one employment place and at least one employment position, and wherein the at least one employment place and the at least one employment position have corresponding geographic coordinates;
receive and store user geographic location information from the at least one user;
match the stored user geographic location information with the corresponding geographic coordinates of the at least one employment place and the at least one employment position;
return employment information within at least one user-defined threshold to the at least one user for display;
receive and store measures from the at least one user;
receive input from the at least one user regarding a current employment position held by the at least one user;
receive and store at least one feedback from the at least one user about the at least one employment place and the at least one employment position;
aggregate and analyze the at least one feedback from the at least one user about the at least one employment place and the at least one employment position; and
derive at least one score for the at least one employment place and the at least one employment position based on the aggregated and analyzed at least one feedback from the at least one user.

18. The system of claim 17, wherein the at least one score ranks the at least one employment place within at least one distance threshold relative to the user geographic location information.

19. The system of claim 17, wherein the at least one score is derived through machine learning.

20. The system of claim 17, wherein the server is further configured to:
establish at least one geofence relative to the stored user geographic location information;
receive, from the at least one user, at least one desired employment information selected from the group consisting of at least one employment place, at least one employment position, and combinations thereof; and
send, to the at least one user, at least one message when the at least one desired employment information occurs within the at least one geofence.
